(19) United States
(12) Patent Application Publication
(10) Pub. No.: US 2008/0165375 A1
(43) Pub. Date: Jul. 10, 2008

(54) IMAGE-PROCESSING CONTROL DEVICE

(75) Inventor: Akira MURAKATA, Tokyo (JP)

Correspondence Address: COOPER & DUNHAM, LLP, 1185 AVENUE OF THE AMERICAS, NEW YORK, NY, 10036, US

(73) Assignee: Ricoh Company, Ltd, Tokyo (JP)

(21) Appl. No.: 11/970,672

(22) Filed: Jan. 8, 2008

(30) Foreign Application Priority Data
Jan. 10, 2007 (JP) 2007-002234

(51) Int. Cl. H04N 1/52

(52) U.S. Cl. 358/1.9

(57) ABSTRACT

An image-processing control device sets a parameter on an image processing apparatus with respect to each of colors of color image data, or groups the colors into at least a single set of colors and sets a parameter on the image processing apparatus with respect to the set of colors.

### CROSS-REFERENCE TO RELATED APPLICATIONS

The present application claims priority to and incorporates by reference the entire contents of Japanese priority document 2007-002234 filed in Japan on Jan. 10, 2007.

### BACKGROUND OF THE INVENTION

1. Field of the Invention

The present invention relates to an image-processing control device.

2. Description of the Related Art

Technological advancements have given way to emergence of a digital copying machine that creates a digital copy of an image, amongst conventional analog counterparts. Examples of enabling technologies include an image scanner, and electrophotographic printer. A scanning (image reading) apparatus can optically scan the image of a document using a line sensor having a plurality of CCD photoelectrical transducers, and outputs the image as digital data (image data). An electrophotographic printer can print (form) an image onto a sheet by irradiating a photoconductor with laser beams modulated based on image data to form an electrostatic latent image on the surface thereof, developing the electrostatic latent image into a toner image, and transferring the toner image onto the sheet.

Because the digital copying machine is more operable with other apparatus that handles digital image data, the digital copying machine has soon come to be provided with various functions, such as those of a facsimile, a printer, or a scanner. This led to advent of a digital multi-functional product (hereinafter, also referred to as “MFP”), which is no longer a simple digital copying machine.

Recently, the MFPs have come to have more functions due to further technological improvements. For example, a large capacity of memory, such as a hard disk drive (HDD), became available with a lower cost. Faster communication has become widely available thanks to networking technologies. Central processing unit (CPU) throughput has improved greatly. Various technologies relating to digital image processing (e.g., compression) have developed. Along with the development, the MFPs have come to be used in various ways. For example, the MFPs are used in situations described in (1) to (3) below.

(1) A small MFP, paired with a personal computer (PC), is readily used as a copier, a facsimile machine, a printer, or a scanner by a single user selecting one of these functions.

(2) A medium-sized MFP, having a certain level of performance (printing throughput) and functions such as sorting, punching, and stapling, is shared among a plurality of users, such as department or sections of a company.

(3) A large, high-performance, high-quality multi-functional MFP is used in a department whose main function requires concentrated amount of copying, or in a company conducting business related to a copying service.

The MFPs have diversified into such classes of products, from the small to the large. Some of the functions provided to the MFPs might be required in all of these classes, but some are required only in one or a few. For example, the large MFP requires post-processing functions such as punching, stapling, or folding to the sheets, or a function to file the digital data simultaneously while making a copy. The small-sized MFP is now demanded to have various functions such as Internet facsimile or PC facsimile, or high-quality printing with a special sheet for personal usage.

Manufactures have been building, selling, and providing systems having a set of functions required for all classes, targeting to such various and diversified MFP market.

Value of information in business has long been recognized, and the companies are demanded not only to deliver accurate information reliably in a timely manner, but also to communicate the information effectively in an easy-to-understand representations. As mentioned above, the telecommunication technologies improved in the speed and became widely disseminated, a small-sized memory with a large capacity has become available at lower cost, and a high-performance PC became available. Along with such trend, new technologies that allow effective usage of information with digital data have also emerged. The MFPs are now desired to have or to be incorporated with such new technologies for handling digital image data, which is one type of the digital data.

Because the diverse products have become available, a user can now provide settings to more functions using an operating unit. In return, an image-processing control device has come to be required to control the increased number of requests. A middleware-based digital signal processor (DSP) can implement more diversified image processes compared with a conventional hardware-based application specific integrated circuit (ASIC), because computer programs and data can be replaced by changing image process parameters. The diverse image processes can be supported in this manner. However, the image-processing control device is required to perform complicated operations to control such DSP enabling diversified processes. Furthermore, because specifications of a DSP can be changed easily, the image-processing control device is required to be able to keep up with such a change that is expected to be done often, promptly and reliably. In summary, an image-processing control device is demanded not only to provide the controls for various requests input from the operating unit, but also to support specification changes in a flexible manner.

However, because a DSP is more expensive than an ASIC, an ASIC is still used for implementation of image processes that does not require frequent changes. Because, depending on applications, such element is also selected, or used additionally to implement an image process, an image-processing control device for such process is also required.

Furthermore, as the multi-functional MFP has come to be connected with a copy machine or to a network, the MFP has come to be used in many more applications, such as a printer, a scanner, or a facsimile. By connecting users (actually terminals being used by the users) to a network, the MFP can be used by a plurality of users simultaneously. Therefore, it has become important for an image-processing control device to manage resource (data-processing device) assigned to the image processes. For example, one of the users can issue a print command while another user is making a large volume of copies. The image-processing control device is required to manage status of the image processing resource, and upon determining that simultaneous executions are not possible, inform the user, who issued the execution request later in time, of the wait status of the image process control, and prompt the user to issue the request again.

A currently mainstream MFP can support scanning and outputting of a color image, in contrast to the conventional MFP that support only monochrome printing. Thus, handling of color information has become important in the image-processing control device, with the shift from monochrome to colors. The number of printable colors in a given type of data-processing device depends on the capacity of thereof, such as ASIC or DSP, and on the number of the data-processing device provided to the MFP.

Especially, an MFP having a four-tandem drum printing engine (image outputting apparatus) can form a full-color image by a single printing process using drums for four colors: cyan, magenta, yellow and black, arranged in line, unlike a conventional MFP requiring a single drum to be rotated four times. This means that the data-processing device in such an MFP can be specified to perform the image processes of a specified color in a predetermined time period. Because the single data-processing device is set with four sets of the image-processing parameters, corresponding to each color of cyan, magenta, yellow, and black, the image-processing control device is required to be able to provide such information, corresponding to each color, to the data-processing device. Some high-performance MFPs include a plurality of data-processing devices, each corresponding to each color. In such a MFP, the image-processing control device is required to be able to be switched among the data-processing devices upon setting the image-processing parameters of each color.

Therefore, an MFP providing a color printing service requires a color image-processing control device that can set image-processing parameters to a specified data-processing device.

Japanese Patent Application Laid-open Nos. 8-328528, 8-305840, and 2001-333282 discloses conventional technologies in which, when monochrome image processing or color image processing is specified, a single controller is switched to set corresponding image-data parameters to one of data-processing devices.

The controller described in Japanese Patent Application Laid-open Nos. 8-328528 and 8-305840 can set a plurality of parameters all together upon determining type of image processing, i.e., monochrome or color. In such a case, however, image processing cannot be switched to another for each color. The controller described in Japanese Patent Application Laid-open No. 2001-333282 cannot support setting parameters corresponding to each color of the four-tandem drum printing engine to the data-processing devices.

### SUMMARY OF THE INVENTION

It is an object of the present invention to at least partially solve the problems in the conventional technology.

According to an aspect of the present invention, there is provided an image-processing control device that is configured to be communicatively connected to an image processing apparatus that performs image processing on image data based on processing parameters. The image-processing control device includes a parameter setting unit that sets a processing parameter on the image processing apparatus with respect to each of colors of color image data, or groups the colors of the color image data into at least a single set of colors and sets a processing parameter on the image processing apparatus with respect to the set of colors.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an image forming apparatus to which is applied an image-processing control device according to a first embodiment of the present invention;

FIG. 2 is an example of a flow of image data upon forming of a full-color image with a copy application;

FIG. 3 is an example of a flow of image data upon forming of a monochrome image using a copy application;

FIG. 4 is an example of a flow of image data upon distribution of a full-color scanned image using a scanner application;

FIG. 5 is an example of a flow of image data upon distribution of a monochrome scanned image using a scanner application;

FIG. 6 is an example of a flow of image data upon provision of a full-color print using a printer application;

FIG. 7 is an example of a flow of image data upon provision of a monochrome print using a printer application;

FIG. 8 is an example of a flow of image data upon transmission of a facsimile using a facsimile application;

FIG. 9 is an example of a flow of image data upon receipt of a facsimile using a facsimile application;

FIG. 10 is a flowchart of an example of color division setting performed by the image-processing control device shown in FIG. 1;

FIG. 11 is a block diagram of an example of relevant part of the MFP shown in FIG. 1;

FIG. 12 is an example of bit assignment to color units;

FIG. 13 is a flowchart of another example of color division setting performed by the image-processing control device shown in FIG. 1;

FIG. 14 is another example of a flow of image data upon forming of a full-color image using a copy application;

FIG. 15 is a block diagram of another example of relevant part of the MFP shown in FIG. 1;

FIG. 16 is a flowchart of still another example of color division setting performed by the image-processing control device shown in FIG. 1;

FIG. 17 is a block diagram of an example of relevant part of the image-processing control device shown in FIG. 1;

FIG. 18 is a block diagram of another example of relevant part of the image-processing control device shown in FIG. 1;

FIG. 19 is a timing chart for explaining the timing at which an image-processing control device of FIG. 18 sets image-processing parameter and data-processing devices perform image processing for continuous full-color copying;

FIG. 20 is another example of a flow of image data upon forming of a full-color image using a copy application;

FIG. 21 is a block diagram of another example of relevant part of the MFP shown in FIG. 1;

FIG. 22 is a block diagram of still another example of relevant part of the image-processing control device shown in FIG. 1;

FIG. 23 is a block diagram of a setting-value calculating unit shown in FIG. 22;

FIG. 24 is a block diagram of an ASIC setting unit shown in FIG. 22;

FIG. 25 is a block diagram of a DSP setting unit shown in FIG. 22;

FIG. 26 is an example of a table of abstract parameters in a library shown in FIG. 23;

FIG. 27 is an example of a table of original values used for calculation in the library shown in FIG. 23;

FIG. 28 is an example of a table of ASIC parameters in a library shown in FIG. 24;

FIG. 29 is an example of a table of computer programs (image-processing parameters) in a library shown in FIG. 25;

FIG. 30 is an example of a table of data (image-processing parameters) in the library shown in FIG. 25;

FIG. 31 is a flowchart of an example of a process performed by the image-processing control device of FIG. 22 in response to a Calculation Request (CALC);

FIGS. 32 and 33 are flowcharts of an example of a process performed by the image-processing control device of FIG. 22 in response to a Setting Request (SET);

FIG. 34 is a flowchart of an example of a process performed by the image-processing control device of FIG. 22 in response to an Ending Request (END);

FIGS. 35 and 36 are flowcharts of another example of a process performed by the image-processing control device of FIG. 22 in response to a Setting Request (SET);

FIG. 37 is a flowchart of another example of a process performed by the image-processing control device of FIG. 22 in response to an Ending Request (END); and

FIGS. 38A and 38B are schematic diagrams for explaining advantages of the MFP shown in FIG. 1.

### DETAILED DESCRIPTION OF THE PREFERRED EMBODIMENTS

Exemplary embodiments of the present invention are described in a specific manner with reference to the appended drawings. In the embodiments described below, the present invention is explained, by way of example, as being applied to an image forming apparatus, specifically, a digital MFP (multifunction product) that combines any or all the functions of a copier, a scanner, a printer, and a facsimile machine.

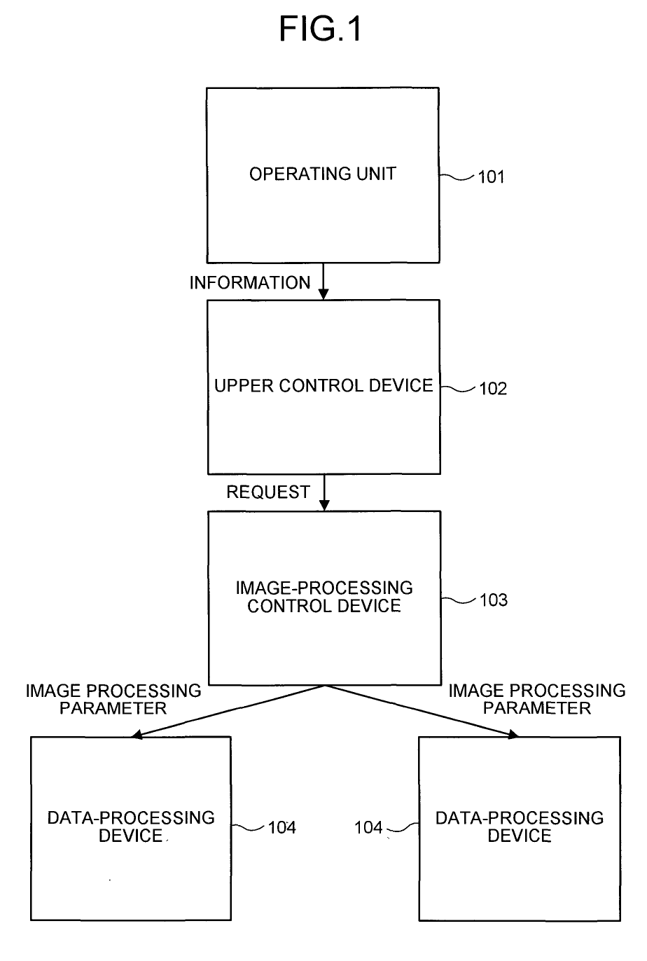

FIG. 1 is a block diagram of an MFP as an image forming apparatus to which is applied an image-processing control device 103 according to a first embodiment of the present invention. In FIG. 1 is shown a relation between the image-processing control device 103 and other units of the MFP.

The MFP includes an operating unit 101, an upper control device 102, the image-processing control device 103, and a data-processing device 104. The operating unit 101 allows a user to input his/her requests. The upper control device 102 is provided to manage information input via the operating unit 101. The image-processing control device 103 controls loading of image-processing parameters (computer programs and data) to the data-processing device 104, and controls the status of the data-processing device 104. A plurality of (or a single) data-processing devices 104 are provided to perform image processing based on the image-processing parameters loaded by the image-processing control device 103. Although not shown in FIG. 1, the MFP also includes a scanner and a plotter as an output unit (described later).

The user can input various requests from the operating unit 101 to provide various settings.

The upper control device 102, as a servicing layer, receives information from the operating unit 101, divides the information into tasks based on contents and timing of a setting provided, and communicates the tasks as requests to the image-processing control device 103.

The image-processing control device 103 receives the requests from the upper control device 102, converts the requests into the image-processing parameters to be set to the data-processing device 104 depending on the request level thereof, and loads the converted parameters to the data-processing device 104.

The upper control device 102 can receive various types of information from the operating unit 101. Examples of such information include application specifying information that specifies the type of an application program (application) used, mode information that indicates a mode such as character mode, or function level information that directly specifies a program number of an MTF filter, or service commands.

The image-processing control device 103 receives a request containing such information from the upper control device 102. The image-processing control device 103 converts the received request into detailed image-processing parameters that can be loaded into the data-processing device 104. The image-processing parameters are loaded to the data-processing device 104, and written into the internal memory provided therein.

The image-processing control device 103 uses a microcomputer having at least a CPU, a read only memory (ROM), and a random access memory (RAM). The CPU loads a computer program from a storage unit such as HDD into the ROM or the RAM to execute it to implement a parameter setting unit.

Each of the data-processing devices 104 performs image processing to color image data based on the image-processing parameters that have been set at an earlier step.

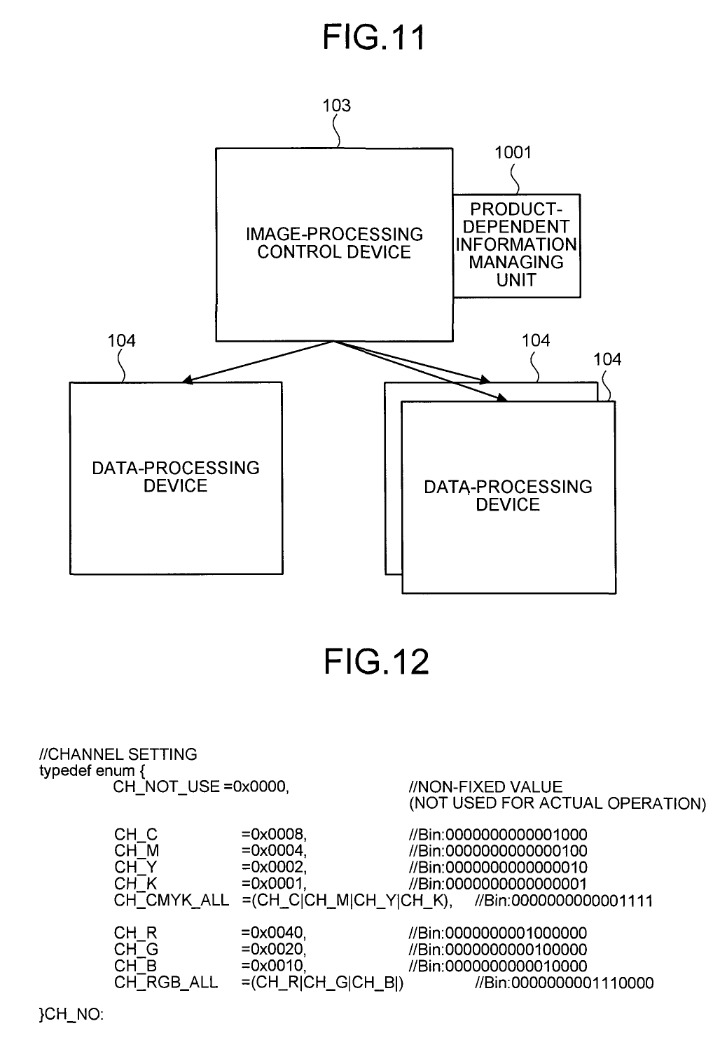

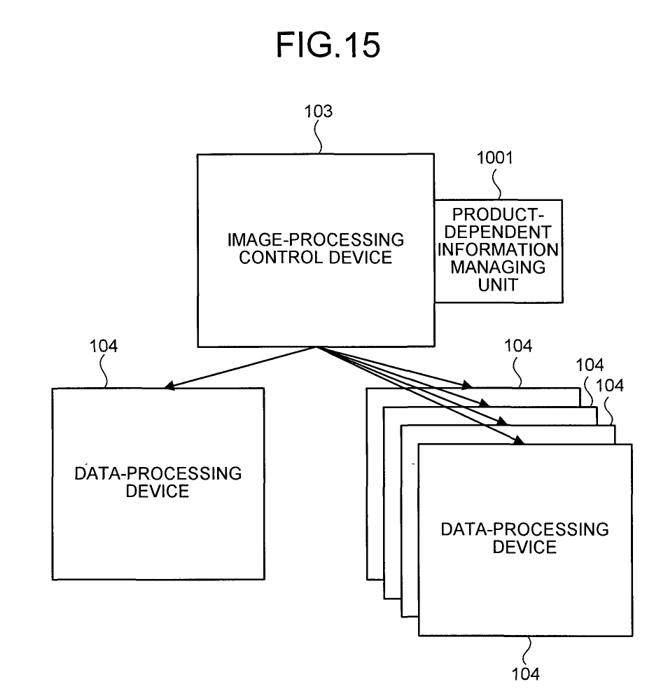

Each of the data-processing devices 104 can be of a different type (the same can be said for those shown in FIGS. 11 and 15, which are to be explained later). For example, the data-processing device 104 shown at left in FIG. 1 can be of a hardware-based processor, and the other shown at right in FIG. 1 can be of a middleware-based processor (middleware). If more of the latter data-processing devices (middleware) 104 are used to improve performance of printing operation, each of such data-processing devices 104 requires less time to complete the image processing. The number of the data-processing devices 104 to be provided in the MFP can be determined based on the type of the MFP, i.e., middle-speed or high-speed (see FIGS. 11 and 15).

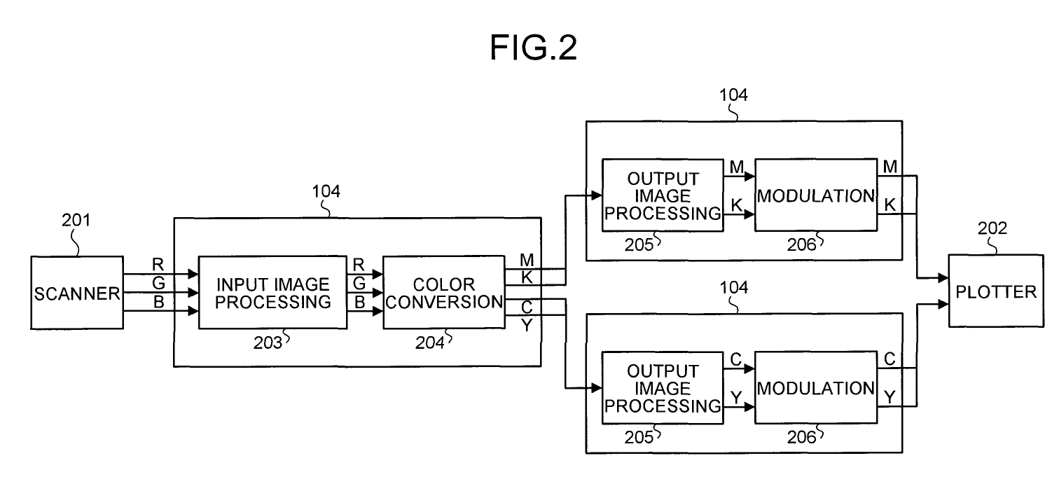

FIG. 2 is an example of a flow of image data upon forming of a full-color image with a copy application.

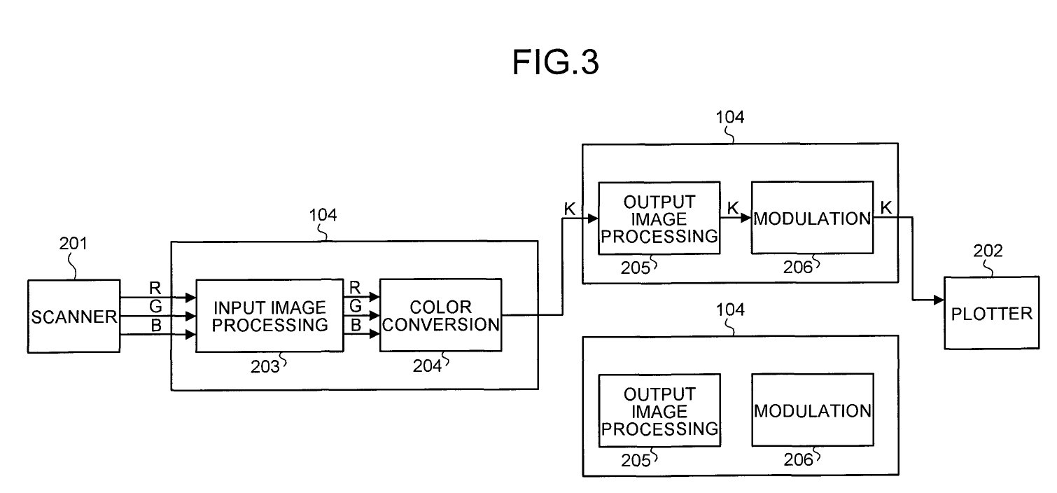

FIG. 3 is an example of a flow of image data upon forming of a monochrome image using a copy application.

The MFP includes a scanner 201 and a plotter 202 (not shown in FIG. 1). The scanner 201 reads an RGB (red, green, and blue) image. The plotter 202 forms a CMYK (cyan, magenta, yellow, and black) image and outputs it. It is herein assumed that the MFP is of average-speed type, having three data-processing devices 104, one at a former stage and the other two at the latter stage.

The MFP performs the following operations upon provision of a full-color copy service.

As shown in FIG. 2, the scanner 201 reads an RGB image and generates digital image data. The data-processing device 104 at a former stage receives the digital image data, and applies an input (scanner-related/correction) image processing 203 to the image data. More specifically, the data-processing device 104 applies the input image processing 203 to the image data, and then performs a color conversion 204 to convert the RGB image data (RGB signal) into CMYK image data (CMYK signal). The two data-processing devices 104, provided at the latter stage, make outputs to the plotter 202, one for MK and the other for CY. The data-processing device 104 at the former stage sends the MK image data to the MK data-processing device 104 at the latter stage, and CY image data to the CY data-processing device 104 at the latter stage, respectively.

The only difference between the data-processing devices 104 at the latter stage is the color of the image data received from the data-processing device 104 at the former stage. Therefore, both of the data-processing devices 104 perform an identical output (plotter-related) image processing 205 to output the image data to the plotter, and subsequently perform a modulation 206, i.e., pulse-surface-area modulation, to convert multi-valued data to binary data. After performing these processes, each of the image data is sent to the plotter 202.

The plotter 202 outputs a full-color image onto a sheet based on the CMYK image data received from the data-processing devices 104.

The MFP performs the following operation upon provision of a monochrome copy service.

As shown in FIG. 3, the data-processing device 104 at the former stage operates in the same manner as in forming a full-color image until the image data reaches the scanner-related correcting process 203. However, the color conversion 204 only outputs the K image data.

The subsequent units also need to perform the processes only for the K color. Therefore, only one of the data-processing devices 104 at the latter stage is used to perform the output image processing 205 and the modulation 206. After performing these processing, the image data is sent to the plotter 202.

The plotter 202 outputs a monochrome image onto a sheet based on the K image data received from the data-processing device 104.

Only upon making a full-color copy, it is required to set the image-processing parameters separately for each color. For example, if the plotter 202 is to use the four-tandem drum printing engine, the printing performance can be improved by outputting the prints based on the image data of each color ordered in time series. Therefore, the image-processing parameters need to be set separately for each color, specifically for the output image processing in the full-color copy.

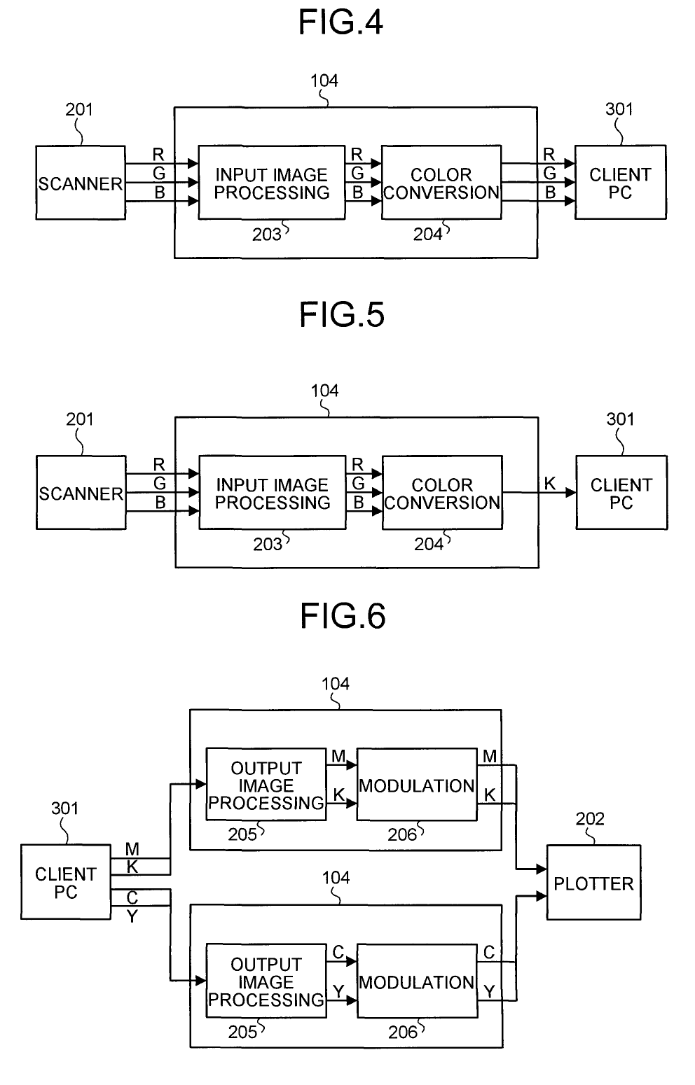

FIG. 4 is an example of a flow of image data upon distribution of a full-color scanned image using a scanner application.

FIG. 5 is an example of a flow of image data upon distribution of a monochrome scanned image using a scanner application.

The MFP does not output any print when a full-color or monochrome scanned image is distributed. Therefore, the image data is not sent to the plotter 202, or the data-processing devices 104 that perform the output image processing (in FIG. 2, the data-processing devices 104 at the latter stage). As shown in FIGS. 4 and 5, different output results are obtained for the color scanning and the monochrome scanning, respectively, by simply outputting the RGB image data as it is, or outputting the image data after converted into K signal in the color conversion 204 provided in the data-processing device 104 at the former stage.

A client PC 301 is an external apparatus connected via a network, such as a local area network (LAN), to the MFP. The client PC 301 makes a request for full-color or monochrome scanning service to the MFP based on an instruction input by a user through an input device such as a keyboard or a mouse, and receives image data from the MFP in response. The scanning service can also be requested from the MFP by specifying which image is to be distributed to which client PC 301 through the operating unit 101. In this case, the image data as a response is sent from the scanner 201 to the specified client PC 301.

FIG. 6 is an example of a flow of an image data upon provision of a full-color print using a printer application.

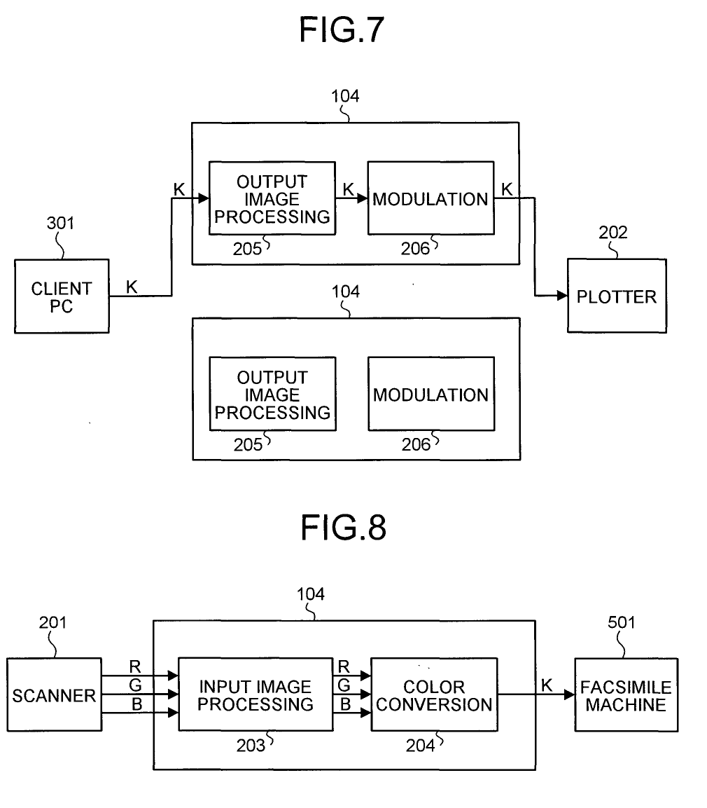

FIG. 7 is an example of a flow of an image data upon provision of a monochrome print using a printer application.

Upon making a full-full color print or a monochrome print, the client PC 301 sends CMYK image data or in K image data to the MFP as shown in FIG. 6 or 7 using a printer driver installed therein, and necessary processing is performed in the MFP. In the MFP, the image data are processed in the same manner as in the output image processing shown in FIG. 2 for the full-color print or in FIG. 3 for the monochrome print. Thus, the explanations thereof are omitted herein.

The image-processing parameters need to be set separately for each color only if a full-color print is requested. For example, if the plotter 202 is to use the four-tandem drum printing engine, the printing performance can be improved by outputting the prints based on the image data of each color ordered in time series. In this manner, specifically for the output image processing of the full-color printing, the image-processing parameters need to be set separately for each color.

FIG. 8 is an example of a flow of image data upon transmission of a facsimile using a facsimile application.

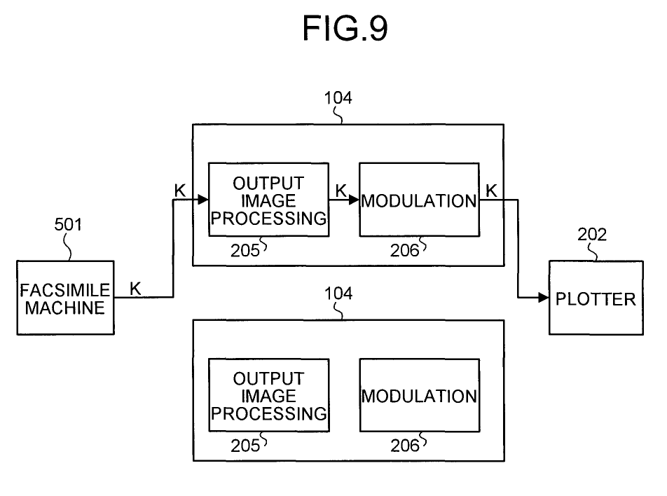

FIG. 9 is an example of a flow of image data upon receipt of a facsimile using a facsimile application. The MFP performs different processing upon transmission and receipt of a facsimile. Upon using a facsimile, only the monochrome K color is processed. Therefore, as shown in FIG. 8, upon transmission of a facsimile to the facsimile machine 501, the image data flows through the MFP in the same manner as for the monochrome scanning distribution. Upon receipt of a facsimile from the facsimile machine 501, the image data flows in the same manner in the MFP as for the monochrome printing.

The single image-processing control device 103 is responsible for all of these applications described above.

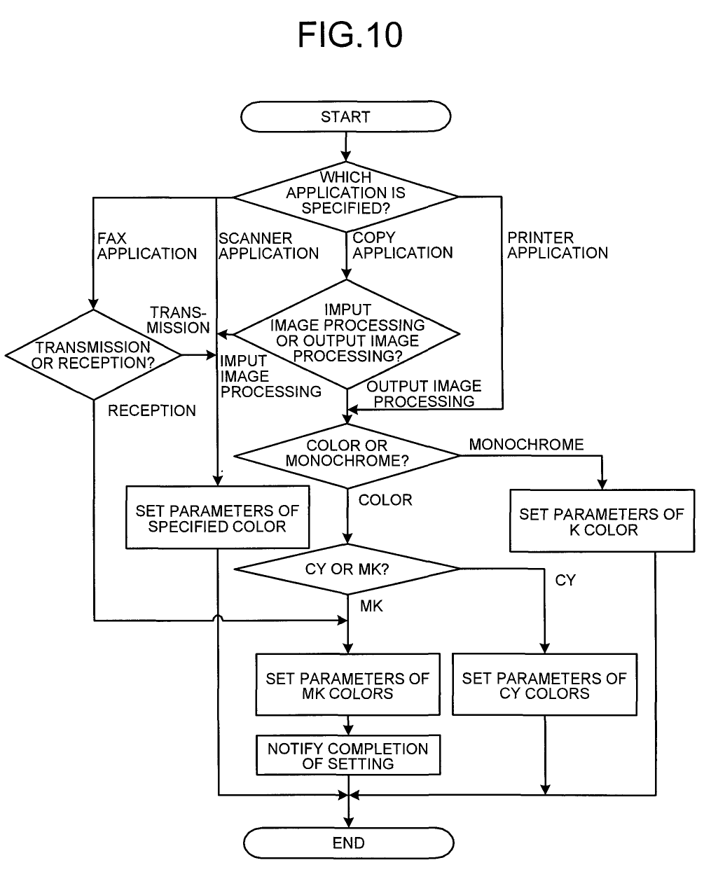

FIG. 10 is a flowchart of an example of a color division setting performed by the image-processing control device 103 according to the first embodiment.

First, the image-processing control device 103 receives a setting request from a user through the operating unit 101. The setting request includes color specifying information and process specifying information, which specify either scanner-related processing or plotter-related processing, in addition to information such as application specifying information. In response to the setting request, color division setting is performed to the data-processing devices 104 to be controlled.

Specifically, the image-processing control device 103 determines the type of application specified by the application specifying information received from the upper control device 102. If the copy application is specified, both the scanner 201 and the plotter 202 need to perform the image processing. Their image processing jobs are switched by the setting request.

As just described, the copy application requires both the image processing jobs. Therefore, the upper control device 102 sequentially issues at least two setting requests, one containing information specifying the scanner-related processing (hereinafter, “input image processing”) and the other containing information specifying the plotter-related processing (hereinafter, “output image processing”).

If the setting request includes information specifying the input image processing, the image-processing control device 103 refers to the color specifying information, and sets the image-processing parameters of specified colors to the data-processing device 104 that performs the input image processing.

With this, the data-processing device 104 can perform the input image processing on input R, G, or B image data, based on the image-processing parameters.

If the setting request includes information specifying the output image processing, the image-processing control device 103 refers to the color specifying information, and determines whether it specifies color or monochrome output.

If monochrome output is specified, color and the data-processing device 104 to be used can be determined simultaneously. Therefore, for example, image-processing parameter for K color is set to the data-processing device 104 that performs the output image processing. If color output is specified, the image-processing control device 103 determines specified colors, i.e., MK or CY, and sets image-processing parameters of the determined colors to the corresponding data-processing device 104 that performs the output image processing.

In the example of FIG. 10, upon forming a full-color (CMYK) image, the image-processing control device 103 receives two setting requests, each containing information specifying the output image processing, in sequence from the upper control device 102. In response to the request, the image-processing control device 103 sequentially sets image-processing parameters of the specified colors to the two data-processing devices 104 that perform the output image processing.

With this, one of the data-processing devices 104 performs the output image processing on input MK image data based on MK image-processing parameters. The other data-processing device 104 performs the output image processing on the input CY image data based on CY image-processing parameters.

Upon completion of the color division setting, the image-processing control device 103 notifies the upper control device 102 of the completion of the process, and enters standby.

Upon receipt of a setting request containing information specifying the scanner application, the image-processing control device 103 operates in the same manner as upon receipt of the setting request with information specifying the copy application and the input image processing.

Upon receipt of a setting request containing information specifying the printer application, the image-processing control device 103 operates in the same manner as upon receipt of the setting request with information specifying the copy application and the output image processing.

If the facsimile application is specified, the image-processing control device 103 determines whether transmission or reception is specified from the information contained in the setting request. If the transmission is specified, the image-processing control device 103 operates in the same manner as upon receipt of the setting request containing the information specifying the copy application and the input image processing. If the reception is specified, the image-processing control device 103 operates in substantially the same manner as upon receipt of the setting request containing the information specifying the copy application and the output image processing (no step for determining whether the specified color is MK or CY).

FIG. 11 is a block diagram of an example of relevant part of the MFP (middle-speed type).

The MFP includes only a single image-processing control device 103. Therefore, the single image-processing control device 103 is required to control a plurality of the data-processing devices 104. The middle-speed and the high-speed products (explained later) should be common in design as much as possible, so that less importing effort is required.

The image-processing control device 103 includes a product-dependent information managing unit 1001. The product-dependent information managing unit 1001 maintains MFP-specific information (middle-speed type) such as the number of the data-processing devices 104, arrangement thereof, and a color corresponding to each of the data-processing devices 104. Because the image-processing control device 103 can just make a reference to the information maintained therein, the only design modification required for a different product is the product-dependent information managing unit 1001, and no change is required in the image-processing control device 103.

According to the first embodiment, four colors (corresponding to full-color image data to be sent to the plotter 202 is divided into two sets of two colors (or multiple sets of colors), so that the image-processing control device 103 can set image-processing parameters of each color to each of the two data-processing devices 104. With this, product-dependent information, indicating which data-processing device 104 performs image processing of which color, can be isolated in the MFP. In this manner, some elements can be shared among different products, and implementation of the data-processing device 104 into the MFP can be simplified.

The colors of color image data to be sent to the plotter 202 can also be divided into units of a single color, and the image-processing control device 103 can set image-processing parameters of each color to each of the four data-processing devices 104.

Because the image processing is performed on the color image data based on the image-processing parameters, the high-performance MFP can perform an image processing using four units each corresponding to one color so that the performance can be improved. The low-price pursuing MFP can use the single data-processing device 104 to perform image processing for a single unit of four colors. In this manner, the number of the data-processing devices 104 can be reduced, resulting in less cost. By designing the image-processing control device 103 not only to control one or more data-processing devices 104, but also to isolate the product-dependent information, the image-processing control device 103 can be utilized easily in different types of products.

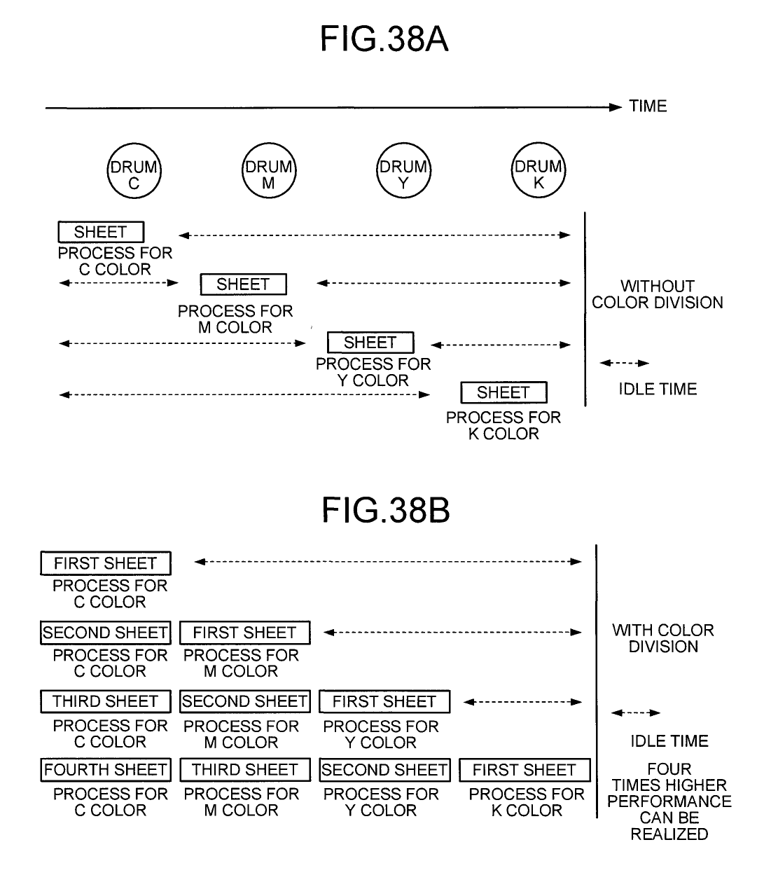

In this example, the single unit of four colors in the image data, which is sent to the plotter 202, is divided into four-color units. The advantages of this example are explained with reference to FIGS. 38A and 38B, by comparing with another example where no such color division setting is performed.

For example, without the color division setting, if continuous full-color printing is performed and the images are formed in the order of C, M, Y, and K, each of the data-processing devices 104 performs the image processing of each color to an Nth sheet sequentially in the order described above. In this setting, even if some of the data-processing devices 104 have finished image processing, such data-processing devices 104 cannot start the next image processing (for example, for the color C) for the N+1th sheet until the image processing for all colors are completed. Therefore, the image cannot be formed on the N+1th sheet until the formation of the image has been completed for the Nth sheet as shown in FIG. 38A.

With the color division setting, each of the data-processing devices 104 performs the image processing of each color unit to the Nth sheet in the same order of image formation. However, on the contrary to the above example, the data-processing device 104 can start the next image processing for the N+1th sheet, as long as the data-processing device 104 has completed the image processing, even if the other image processing has not yet completed. Therefore, as shown in FIG. 38B, the image formation of the N+1th sheet can be started before completing the image formation on the Nth sheet.

Therefore, the color division setting can improve the performance greatly, compared with performance without the color division setting.

FIG. 12 is an example of bit assignment to color units according to a second embodiment of the present invention. According to the second embodiment, the color specifying information, which is input to the image-processing control device 103 as explained in the first embodiment, is assigned a channel (CH) by the upper control device 102.

A total of 16 bits are assigned to represent every color included in the image data, R, G, B, C, M, Y, and K.

It should be noted that the input image processing only handles R, G, and B colors, and the output image processing handles only C, M, Y, and K colors. Therefore, the type of image processing, i.e., scanner-related or plotter-related, can be determined by the color specifying information.

Image-processing parameters of specified colors are set by bit assignment, such that image-processing parameters can be set for all RGB colors (CH_RGB_ALL), or for RG only, or independently for each of the RGB. The same applies to CMYK colors for the output image processing. Thus, image-processing parameters can be set for any combinations of these colors.

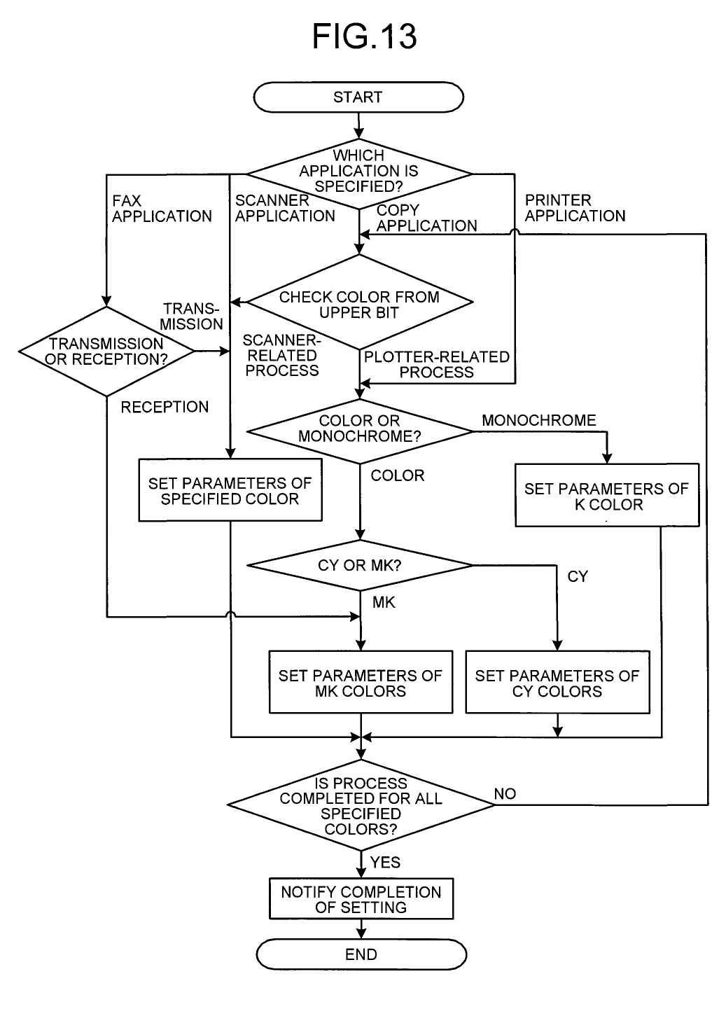

FIG. 13 is a flowchart of another example of color division setting according to the second embodiment (showing control performed when a setting request, containing color specifying information specifying colors by a channel to set image-processing parameters for each of the colors all at the same time).

The color division setting shown in FIG. 13 is different from that shown in FIG. 10 in that color is assigned bits as a channel, and process is repeated for each of one or more color units specified by setting “1” to any of these bits. Besides, there is no conditional branching for determining whether scanner-related or plotter-related processing is specified because it can be determined by the color specifying information specifying colors RGB or CMYK.

According to the second embodiment, the image-processing control device 103 can set image-processing parameters of each color unit according to channel having bits assigned to each color of color image data. In this manner, image-processing parameter can be set in any combination of the colors using the single image-processing control device 103. That is, image-processing parameters can be set either in color units or for all colors at once by specifying a channel, thus supporting both products requiring either setting. Even within a single product, image-processing parameters can be set either in color units or for all colors at once depending on requirements of an application used. Furthermore, image-processing parameters of each color unit can be set based on a channel having bits assigned to each of color units of color image data also in embodiments described below.

According to a third embodiment of the present invention, a high-speed MFP with five data-processing devices 104 is used as an example.

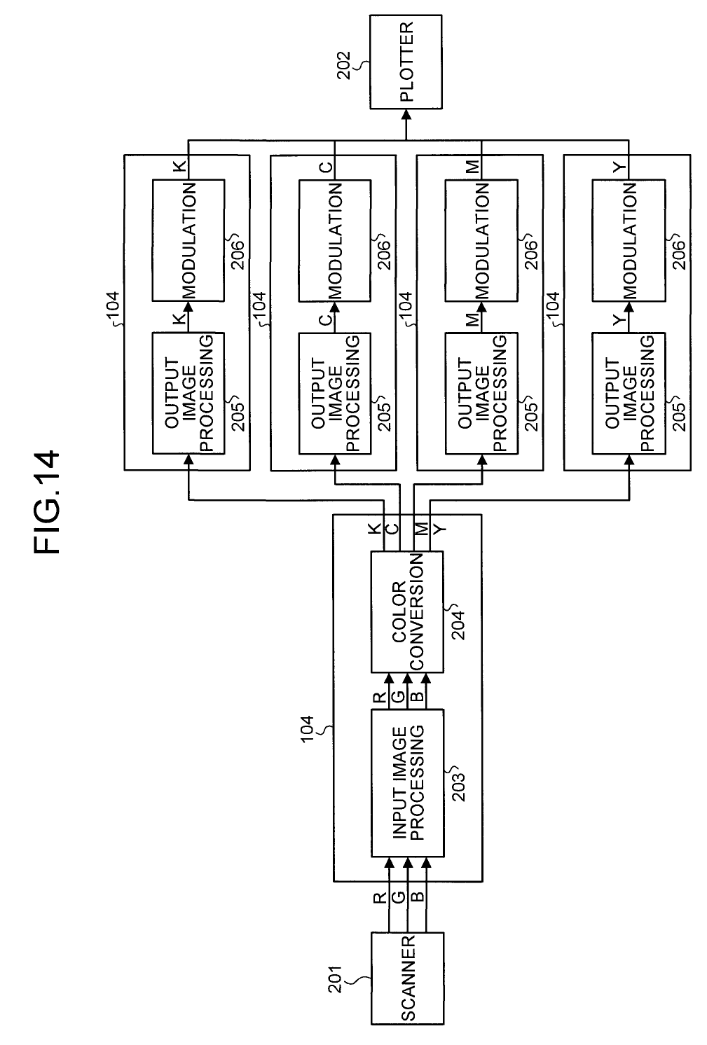

FIG. 14 is another example of a flow of image data upon forming of a full-color image using a copy application.

This high-speed MFP is required to form a full-color image at a higher speed than other products, even though a cost for the machine increases. No color division setting is required for the input image processing; however, the color division setting is required for the output image processing, because the plotter 202 uses a four-tandem drum printing engine that outputs prints based on the image data of each color in time series. The input image processing is performed by the single data-processing device 104 at the former stage. The input image processing 203 and the color conversion 204 are performed to images of each color of RGB and the result thereof, respectively.

The printing speed is important in the high-speed full-color printing. To improve the performance of continuous copying, the output image processing is performed by using four data-processing devices (middleware) 104 at the latter stage. Because the output image processing is largely responsible for the printing speed, four data-processing devices 104 are provided, one for each color, C, M, Y, and K. The data-processing device 104, provided for each color, performs the output image processing 205 and the modulation 206 to the image data of the responsible color, and outputs the processed image data to the plotter 202.

Upon provision of the monochrome copy, only the K image data is sent to the data-processing device 104 that performs the corresponding output image processing. For the full-color or monochrome printer, scanner, or facsimile application, the processes are the same except for the number of the data-processing devices 104 used, and the color for which each of the data-processing devices 104 is responsible. Thus, the explanation thereof is omitted herein.

FIG. 15 is a block diagram of another example of relevant part of the (high-speed) MFP. Like reference numerals refer to portions corresponding to those in FIG. 11.

The only difference between the high-speed MFP shown in FIG. 15 and the middle-speed MFP shown in FIG. 11 are the number of data-processing devices 104 provided for the output image processing, and the color for which each of the data-processing devices 104 is responsible for. By changing the product-dependent information maintained in the product-dependent information managing unit 1001, the architectural change in the image-processing control device 103 can be minimized, and importability can be improved.

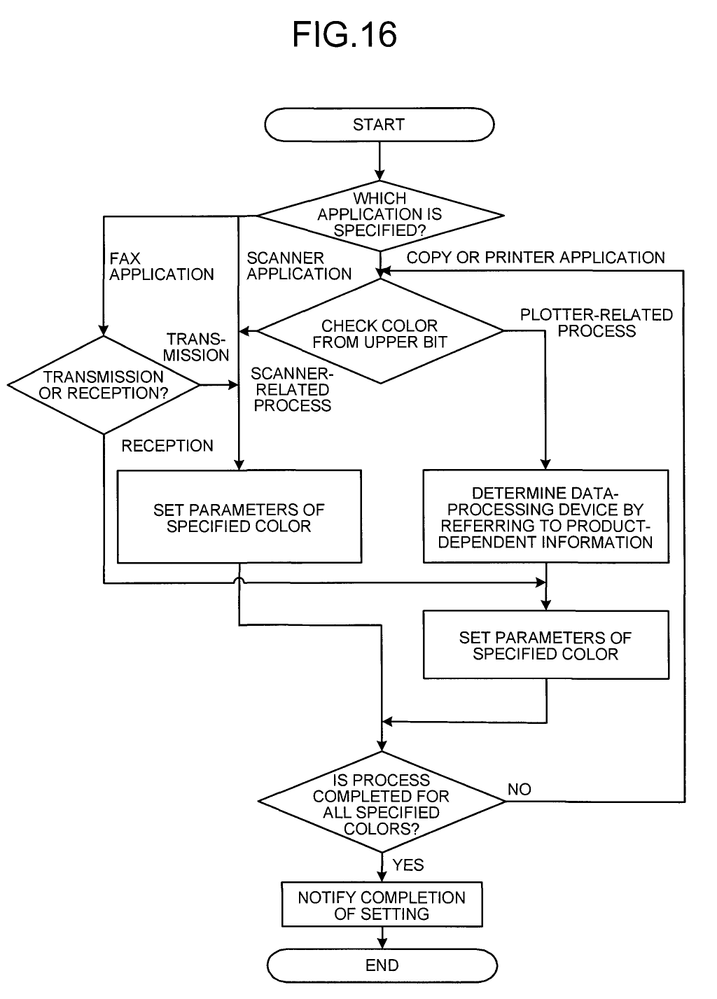

FIG. 16 is a flowchart of another example of color division setting performed by the image-processing control device 103.

This example of the color division setting is applied to an image-processing device of the high-speed MFP having four data-processing devices 104 for the output image processing. The process shown in FIG. 16 is basically the same as that shown in FIG. 13 except for the number of the data-processing devices 104 provided for the output image processing.

In the process shown in FIG. 16, the image-processing control device 103 no longer determines whether the color type is of color or monochrome, or whether the specified color is MK or CY. Alternatively, the image-processing control device 103 refers to the information maintained in the product-dependent information managing unit 1001, sequentially determines which data-processing device 104 should be provided with the settings of each specified color unit, and sets the corresponding image-processing parameters to the data-processing device 104.

After checking the image-processing parameters for the each color unit specified by the channel, and completing the processes (color division setting) for every specified color, the image-processing control device 103 notifies the completion thereof to the upper control device 102, and goes into an idle.

According to the third embodiment, the image-processing control device 103 controls the data-processing devices 104, each assigned with a process corresponding to each color unit. For example, the control becomes complicated if there is a plurality of image-processing control devices in a single product. Therefore, controlling the data-processing devices 104, each provided for each color unit, by the single image-processing control device 103, the controlling structure can be further simplified.

Described below is a fourth embodiment of the present invention. It is only explained herein structure of and control performed by the image-processing control device 103 upon setting the image-processing parameters. The image-processing control device 103 of the fourth embodiment is of basically the same configuration and operates in a similar manner as previously described in the first to third embodiment, and the same explanation is not repeated.

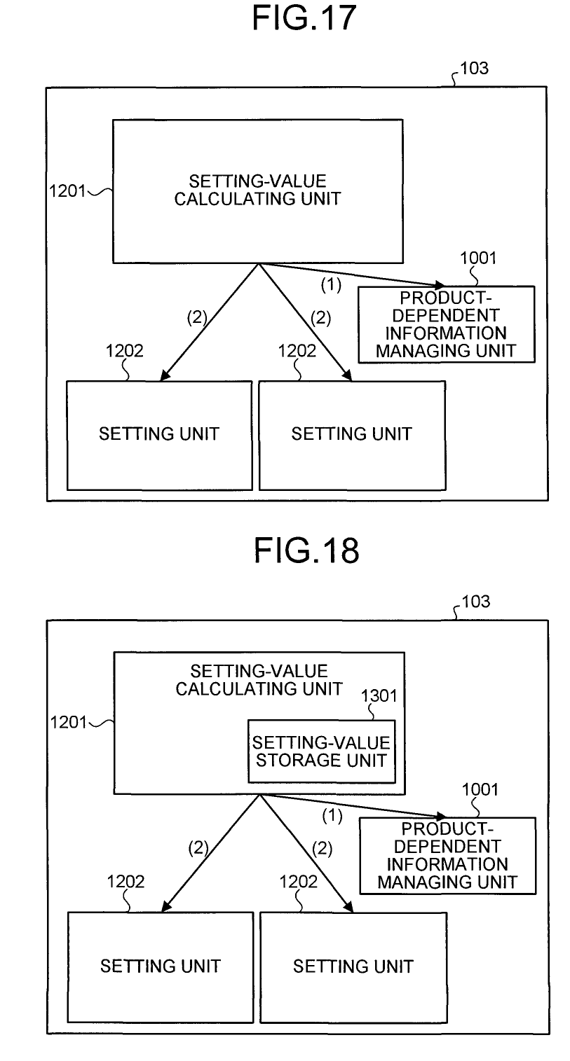

FIG. 17 is a block diagram of an example of relevant part of the image-processing control device 103. The image-processing control device 103 includes a setting-value calculating unit 1201 and two setting units 1202 in addition to the product-dependent information managing unit 1001. The data-processing devices 104 include those of hardware and middleware. Accordingly, the setting units 1202 are provided in two types, for the hardware and the middleware. Only one setting unit 1202 is provided for each type of the data-processing devices 104, because the settings can be provided in the same manner and the setting unit 1202 can be shared, if the data-processing devices 104 are of the same type.

The product-dependent information managing unit 1001 manages information such as the number or types of the data-processing devices 104 provided.

The setting-value calculating unit 1201 calculates setting values (image-processing parameters) to set to the data-processing device 104, which is the controlled unit, based on the calculation request received from the upper control device 102, that is, based on the information input via the operating unit 101 and added in the upper control device 102. The setting-value calculating unit 1201 calculates the image-processing parameters that can be commonly set to each of the setting units 1202.

One of the setting units 1202 (at the left in FIG. 17) is responsible for managing the hardware-based data-processing device 104. In other words, this setting unit 1202 is hardware-setting unit that receives the calculated values from the setting-value calculating unit 1201, and sets the values to the hardware-based data-processing device 104.

The other setting unit 1202 (at the right in FIG. 17) is responsible for managing the middleware-based data-processing device 104; in other words, this setting unit 1202 is middleware-setting unit that receives the calculated values from the setting-value calculating unit 1201, and sets the values to the middleware-based data-processing device 104.

The setting units 1202 are provided in the same number as the data-processing devices 104 provided in the MFP, and set the value in different manners depending on the types of the data-processing device 104.

In the image-processing control device 103, having the structure described above, the setting-value calculating unit 1201 calculates setting values that are to be set to the data-processing devices 104, which are the controlled targets, based on the calculation request received from the upper control device 102. The image-processing control device 103 then refers to the information maintained in the product-dependent information managing unit 1001, determines the implemented data-processing devices 104, and writes the setting values (calculated values), obtained in response to the calculation request, to the setting units 1202 corresponding to the determined data-processing devices 104.

The setting units 1202 provide the written setting values to the data-processing devices 104, which are the controlled targets.

According to the forth embodiment, the image-processing control device 103 is responsible for calculating all the image-processing parameters that are to be set to each of the data-processing devices 104 corresponding each color unit included in the color image data. For example, if the image-processing control device 103 needs to control a continuous operation, such as copying a plurality of sets of duplicates, the image-processing control device 103 calculates the image-processing parameters for a next set of duplicates in advance while the data-processing device 104 is performing image processing based on the image-processing parameters that have been set right before starting copying a set of the duplicates. Subsequently upon completion of printing the set of duplicates and receiving the next copy request, which requires the image-processing parameters to be set to the data-processing device 104, the image-processing parameters that have been calculated in advance are set to the data-processing devices 104. In this manner, the image-processing control device 103 can be utilized efficiently to achieve a high performance.

Described below is a fifth embodiment of the present invention It is only explained herein a structure of and control performed by the image-processing control device 103 upon setting image-processing parameters. The image-processing control device 103 of the fifth embodiment is of basically the same configuration and operates in a similar manner as previously explained in the first to the third embodiment, and the same explanation is not repeated.

FIG. 18 is a block diagram of another example of relevant part of the image-processing control device 103. Like reference numerals refer to portions corresponding to those in FIG. 17.

According to the fifth embodiment, the setting-value calculating unit 1201 further includes a setting-value storage unit 1301 that stores therein setting values calculated by the setting-value calculating unit 1201. Accordingly, the setting unit 1202 need not provide the setting values immediately to the data-processing devices 104 to be controlled, but can delay providing such setting values.

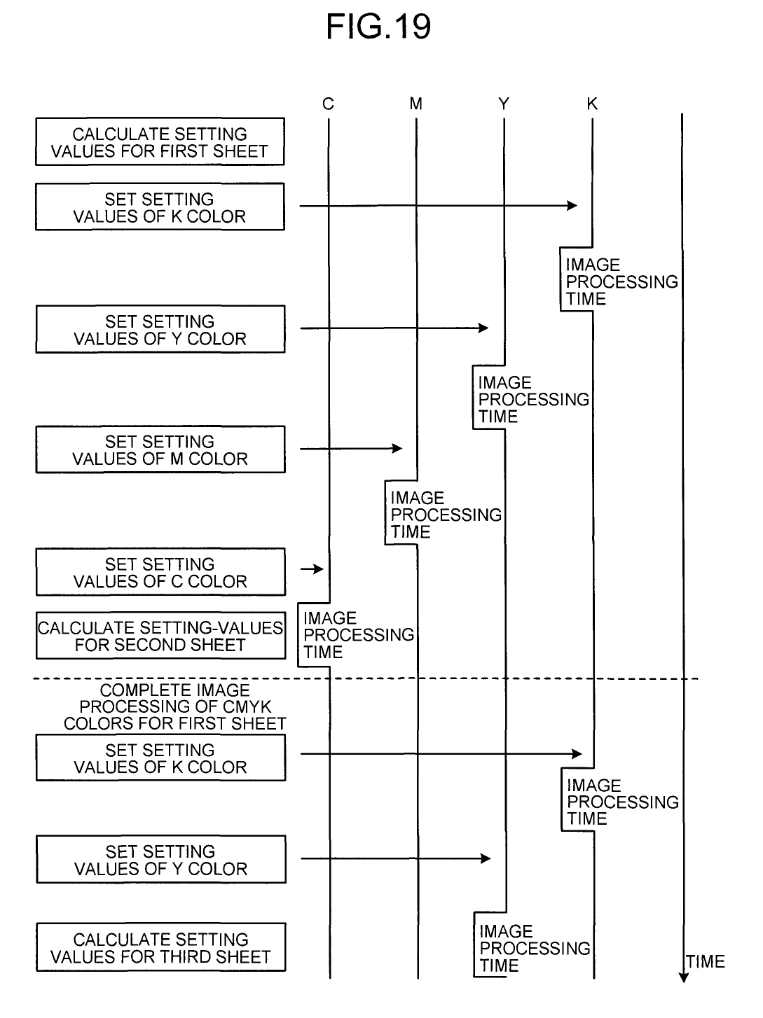

FIG. 19 is a timing chart for explaining the timing at which the image-processing control device 103 of FIG. 18 sets image-processing parameter and the data-processing devices 104 perform image processing for continuous full-color copying.

When a full-color copy is requested, the image-processing control device 103 needs to set image-processing parameters to the data-processing devices 104, corresponding to each of the four colors, C, M, Y, and K, once per sheet, so that the data-processing devices 104 can perform the corresponding image processing. Because it takes time to calculate the image-processing parameters for all the colors C, M, Y, and K and the calculation of the image-processing parameters can be performed in parallel with the image processing, the image-processing control device 103 makes the calculation while time is available.

In the example of FIG. 19, the setting values are calculated for the second sheet before completing the image processing for the first sheet. By storing the results calculated by the setting-value calculating unit 1201 of FIG. 18 to the setting-value storage unit 1301, not only the calculation and setting timing are changed, but also the setting value can be calculated ahead of time when a series of requests are issued, such as in a continuous copy operation. In this manner, the full-color copying performance can be improved.

Provided below are examples of interfaces between the upper control device 102 and the image-processing control device 103 to set the image-processing parameters to the data-processing devices 104 in the timing shown in FIG. 19.

### 1. Calculation Request (CALC)

Argument: information input via the operating unit, process number (1 to 20), color specifying information specifying every color needed to be processed (CMYK)

### 2. Setting Request (SET)

Argument: information input via the operating unit, process number (1 to 20), color specifying information specifying a color needed to be processed (K)

### 3. Ending Request (END)

Argument: information input via the operating unit, process number (1 to 20), color specifying information specifying the color for which the image processing has been completed (K)

The Setting Request SET and the Ending Request END can be specified with divided color units, into which the colors specified in the Calculation Request CALC are divided, and these requests are issued for each of the divided color unit. For example, to perform the image processing at the timing shown in FIG. 19 for all colors, using the one-color units, the requests will be issued in the manner shown below:

1. Calculation Requests CALC (information of the operating unit, process number 1: a first sheet, CMYK)
2. Setting Request SET (information of the operating unit, process number 1: a first sheet, K)
3. Ending Request END (information of the operating unit, process number 1: a first sheet, K)
4. Setting Request SET (information of the operating unit, process number 1: a first sheet, Y)
5. Ending Request END (information of the operating unit, process number 1: a first sheet, Y)
6. Setting Request SET (information of the operating unit, process number 1: a first sheet, M)
7. Ending Request END (information of the operating unit, process number 1: a first sheet, M)
8. Setting Request SET (information of the operating unit, process number 1: a first sheet, C)
9. Calculation Requests CALC (information of the operating unit, process number 2: a second sheet, CMYK)
10. Ending Request END (information of the operating unit, process number 1: a first sheet, C)
11. Setting Request SET (information of the operating unit, process number 2: a second sheet, K)
12. Ending Request END (information of the operating unit, process number 2: a second sheet, K)
13. Setting Request SET (information of the operating unit, process number 2: a second sheet, Y)
14. Calculation Requests CALC (information of the operating unit, process number 3: a third sheet, CMYK)
15. Ending Request END (information of the operating unit, process number 2: a second sheet, Y)

According to the fifth embodiment, the image-processing control device 103 is responsible for calculating all image-processing parameters that are to be set to each of the data-processing devices 104, each corresponding to each color included in the color image data, and stores therein the calculated image-processing parameters. For example, if the image-processing control device 103 needs to control a continuous operation, such as copying a plurality of sets of duplicates, the image-processing control device 103 can calculate and store therein the image-processing parameters for a next set of duplicates in advance while the data-processing device 104 is performing image processing based on the image-processing parameters that have been set right before starting copying a set of the duplicates. Subsequently upon completion of printing the set of duplicates and receiving the next copy request, which requires the image-processing parameters to be set to the data-processing device 104, the image-processing parameters that have been calculated and stored in the image-processing control device 103 in advance are set to the data-processing device 104. In this manner, the image-processing control device 103 is utilized efficiently to achieve a high performance.

Described below is a sixth embodiment of the present invention. The sixth embodiment is basically similar to the fifth embodiment, and therefore, only the difference is explained below.

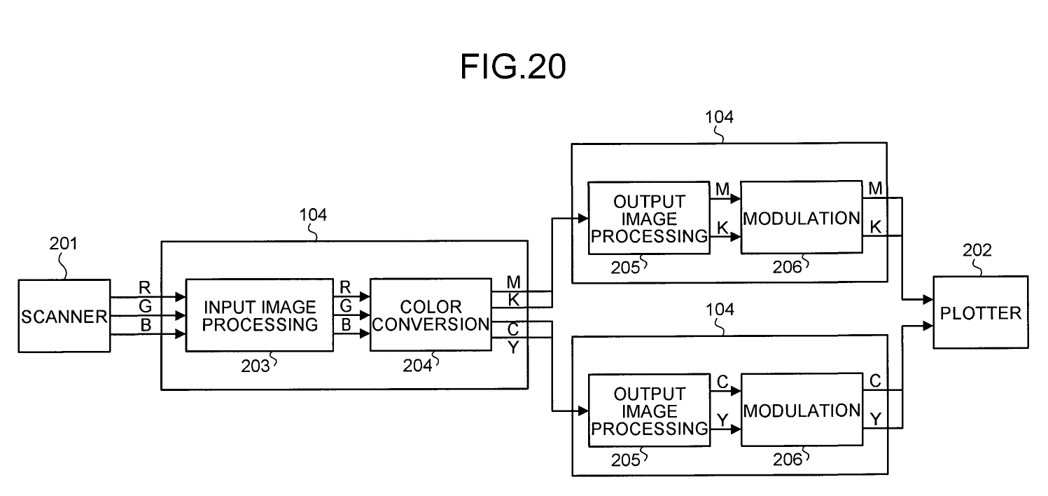

FIG. 20 is another example of a flow of image data upon forming of a full-color image using a copy application.

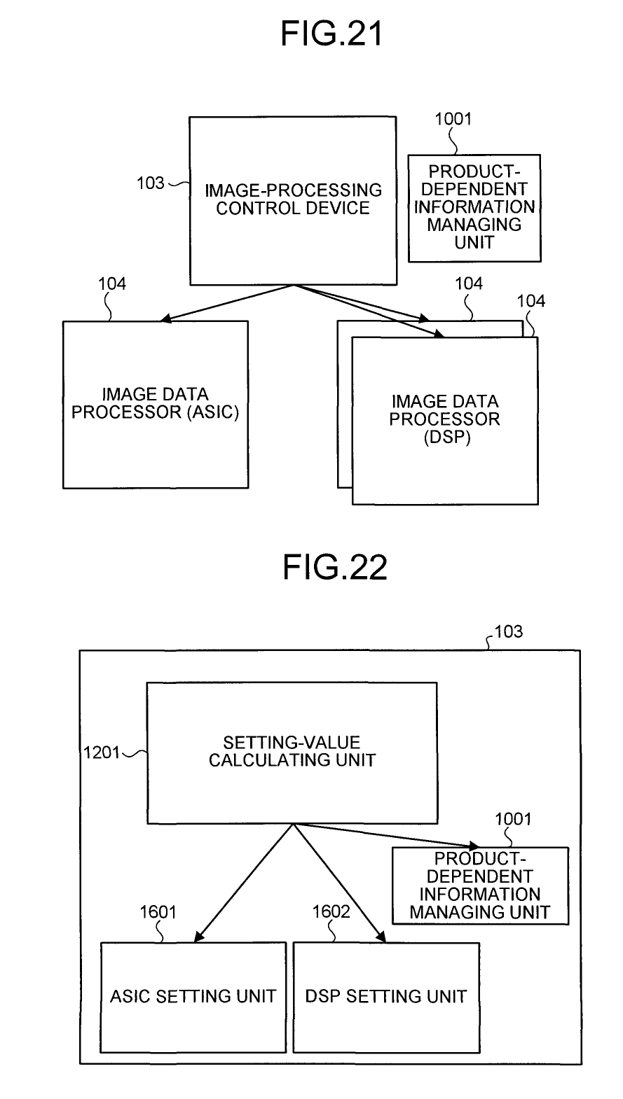

FIG. 21 is a block diagram of another example of relevant part of the MFP (middle-speed type) like reference numerals refer to portions corresponding to those in FIG. 18.

According to the sixth embodiment, the three data-processing devices 104 include a hardware-based ASIC for the input image processing, and two middleware-based DSPs for the output image processing.

In the sixth embodiment, because the output image processing requires image-processing parameters to be set using the color division setting, modifications can be made, for example, by replacing a computer program. Therefore, DSPs are used for the two data-processing devices 104 for the output image processing, so that such modifications can be easily made.

The input image processing is not specified with the color division setting and always specified by each of RGB colors, modifications are seldom made. Therefore, the inexpensive ASIC is used for the single data-processing device 104 that performs the input image processing.

The image-processing control device 103 manages the one data-processing device 104 using the ASIC and the data-processing devices 104 using the DSPs. The two data-processing device (DSP) 104 is responsible for the same color units as those described above for the fifth embodiment. Therefore, the explanation thereof is omitted herein.

FIG. 22 is a block diagram of another example of relevant part of the image-processing control device 103. Like reference numerals refer to portions corresponding to those in FIG. 18.

The image-processing control device 103 includes the product-dependent information managing unit 1001, the setting-value calculating unit 1201, an ASIC setting unit 1601, and a DSP setting unit 1602.

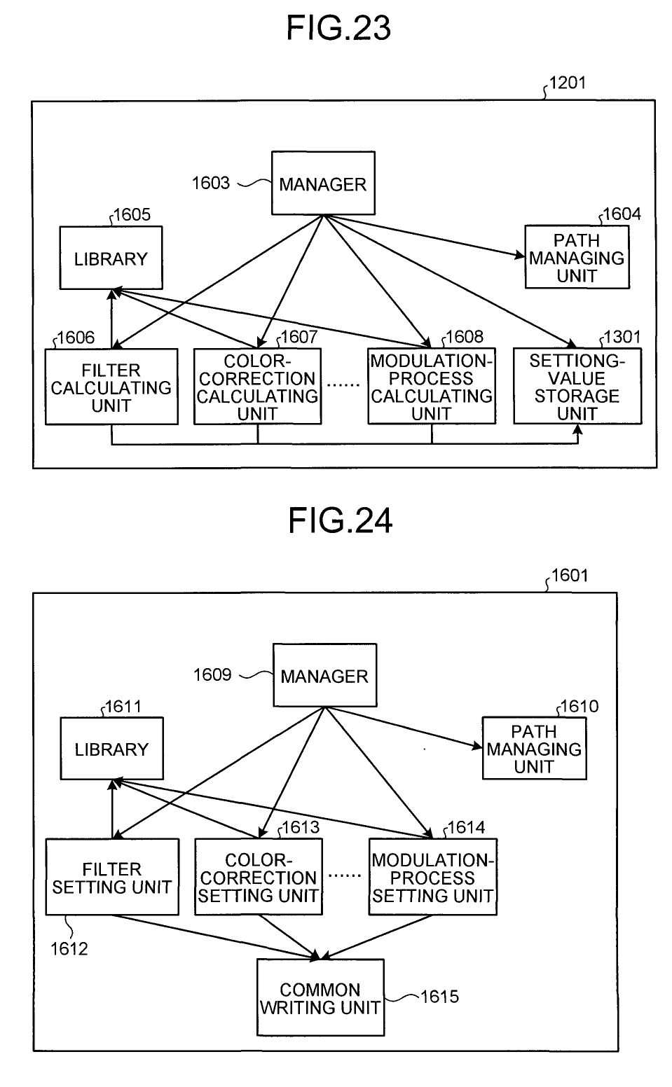

FIG. 23 is a block diagram of the setting-value calculating unit 1201. The setting-value calculating unit 1201 includes a manager 1603, a path managing unit 1604, a library 1605, the setting-value storage unit 1301, and a plurality of calculating units each corresponding to each image processing. The calculating units include a filter calculating unit 1606, a color-correction calculating unit 1607, and a modulation-process calculating unit 1608).

The manager 1603 manages sequences. The path managing unit 1604 calculates the path to the calculating unit that is required to make calculation, based on the information input to the image-processing control device 103.

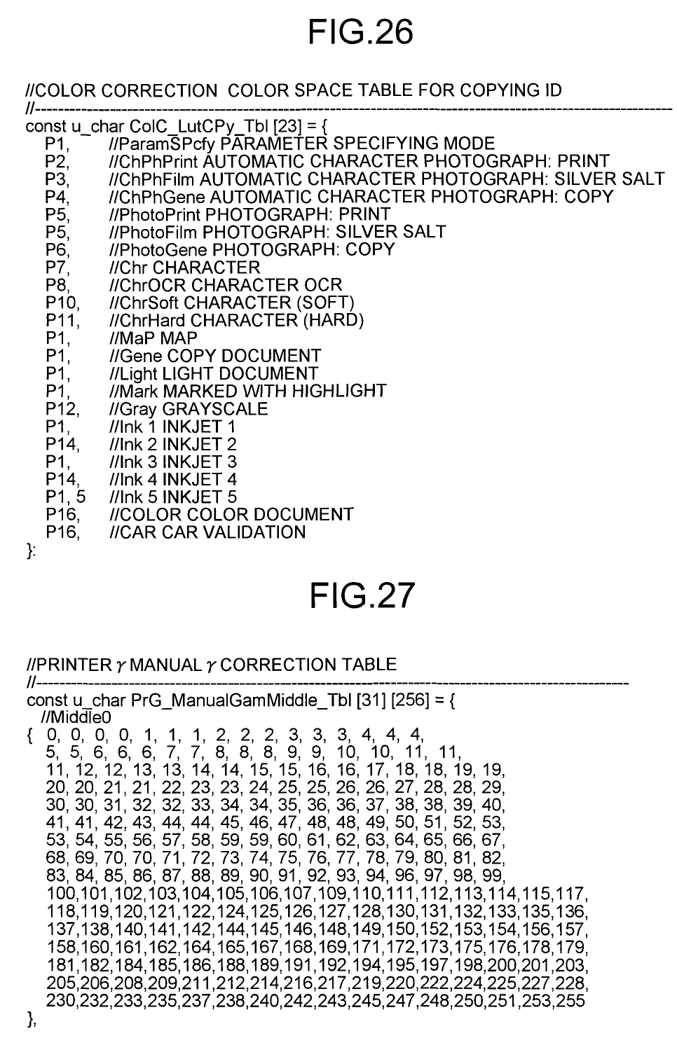

The library 1605 manages a table of abstract parameters or original values used in calculations, such as those shown in FIG. 26 or 27. Depending on the calculating unit, either the abstract parameters or the original values are required in calculation.

The calculating units (the filter calculating unit 1606, the color-correction calculating unit 1607, and the modulation-process calculating unit 1608) calculates setting values (image-processing parameters) for the responsible image processing by referring to the library 1605, and stores the values in the setting-value storage unit 1301 as they are, or makes a calculation to determine the setting values.

The setting-value storage unit 1301 stores therein not only the calculation results from the plurality of the calculating units (the filter calculating unit 1606, the color-correction calculating unit 1607, the modulation-process calculating unit 1608), but also the process number, color specifying information, or information about the data-processing devices 104 (image processor information) responsible for each color unit.

FIG. 24 is a block diagram of the ASIC setting unit 1601. The ASIC setting unit 1601 includes a manager 1609, a path managing unit 1610, a library 1611, a plurality of setting units, and a common writing unit 1615. The setting units include a filter setting unit 1612, a color-correction setting unit 1613, and a modulation-process setting unit 1614.

The manager 1609 manages sequences. The path managing unit 1610 determines the path to the setting unit that requires setting, based on the information stored in the setting-value storage unit 1301 and sent by the setting-value calculating unit 1201.

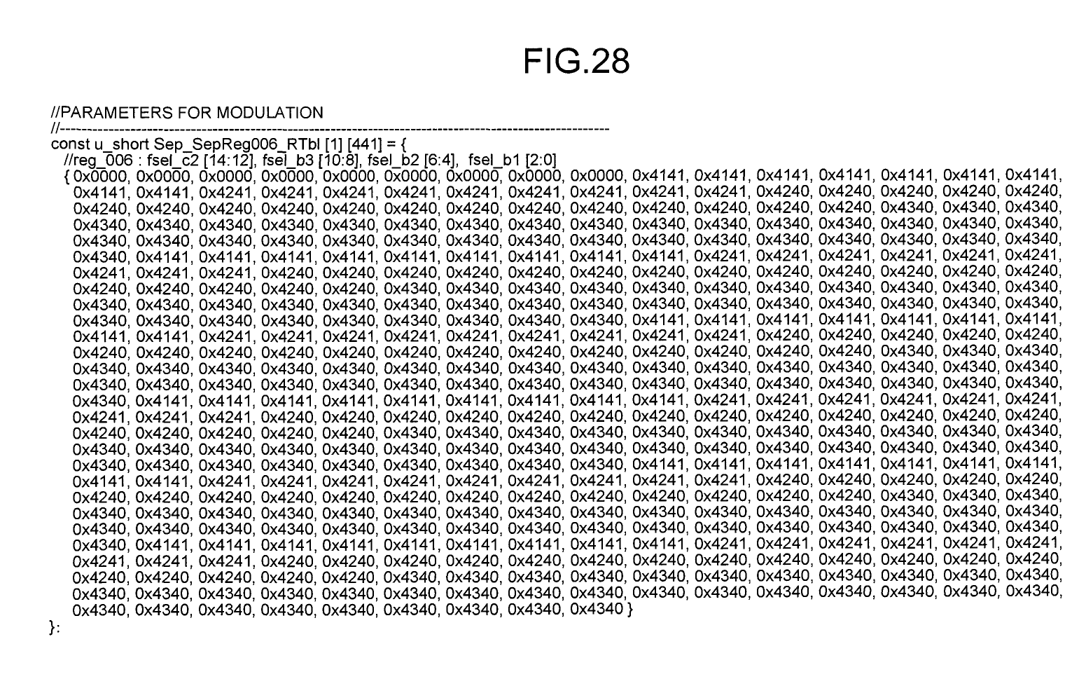

For example, as shown in FIG. 28, the library 1611 manages a table of ASIC parameters, corresponding to the values specified by the abstract parameters.

Each of the setting units (the filter setting unit 1612, the color-correction setting unit 1613, and the modulation-process setting unit 1614) refer to the library 1611 and determines the image-processing parameters to set to the image processing that the setting unit is responsible for.

The common writing unit 1615 writes the image-processing parameters, determined by the setting units (the filter setting unit 1612, the color-correction setting unit 1613, and the modulation-process setting unit 1614), into the data-processing device (ASIC) 104.

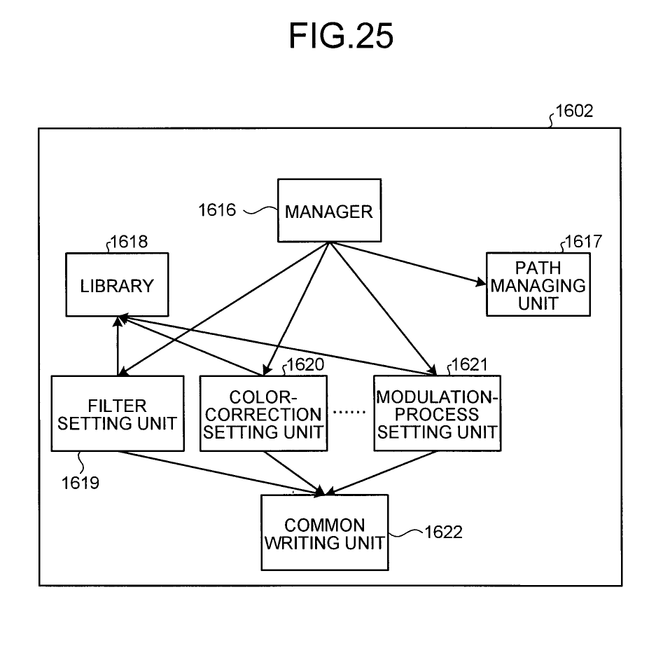

FIG. 25 is a block diagram of the DSP setting unit 1602. The DSP setting unit 1602 includes a manager 1616, a path managing unit 1617, a library 1618, a plurality of setting units, and a common writing unit 1622. The setting units include a filter setting unit 1619, color-correction setting unit 1620, and modulation-process setting unit 1621.

The manager 1616 manages sequences. The path managing unit 1617 determines the path to the setting unit that requires setting, based on the information stored in the setting-value storage unit 1301 and sent by the setting-value calculating unit 1201.

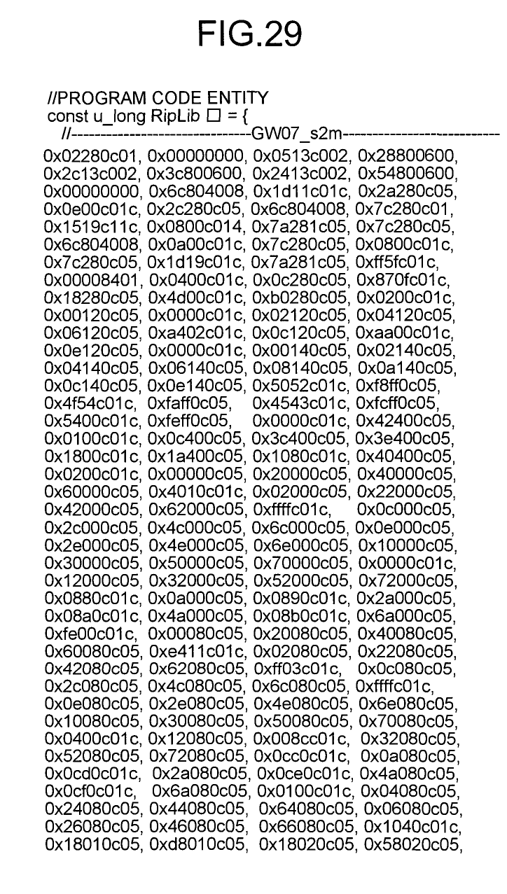

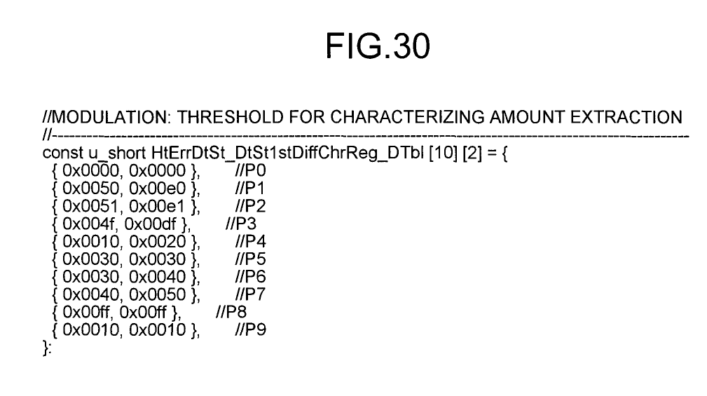

For example as shown in FIGS. 29 and 30, the library 1618 manages a table of computer programs or data that are the image-processing parameters, corresponding to the values specified by the abstract parameters, to be set to the data-processing devices (DSP) 104.

Each of the setting units (the filter setting unit 1619, the color-correction setting unit 1620, and the modulation-process setting unit 1621) refer to the library 1618 and determines the image-processing parameters to set to the image processing that the setting unit is responsible for.

The common writing unit 1622 writes the image-processing parameters, determined by the setting units (the filter setting unit 1619, the color-correction setting unit 1620, and the modulation-process setting unit 1621), into the data-processing device (DSP) 104.

The setting-value calculating unit 1201 is included in any type of the MFPs; however, the ASIC setting unit 1601 or the DSP setting unit 1602 is provided only if the MFP has an data-processing device 104 using the ASIC or the DSP.

According to the sixth embodiment, the MFP includes such data-processing devices 104, and can be configured as shown in FIGS. 22 to 25.

Explained below is the processes performed by each controlling elements in the image-processing control device 103 when the Calculation Request (CALC), the Setting Request (SET), or the Ending Request (END) is issued by the upper control device 102.

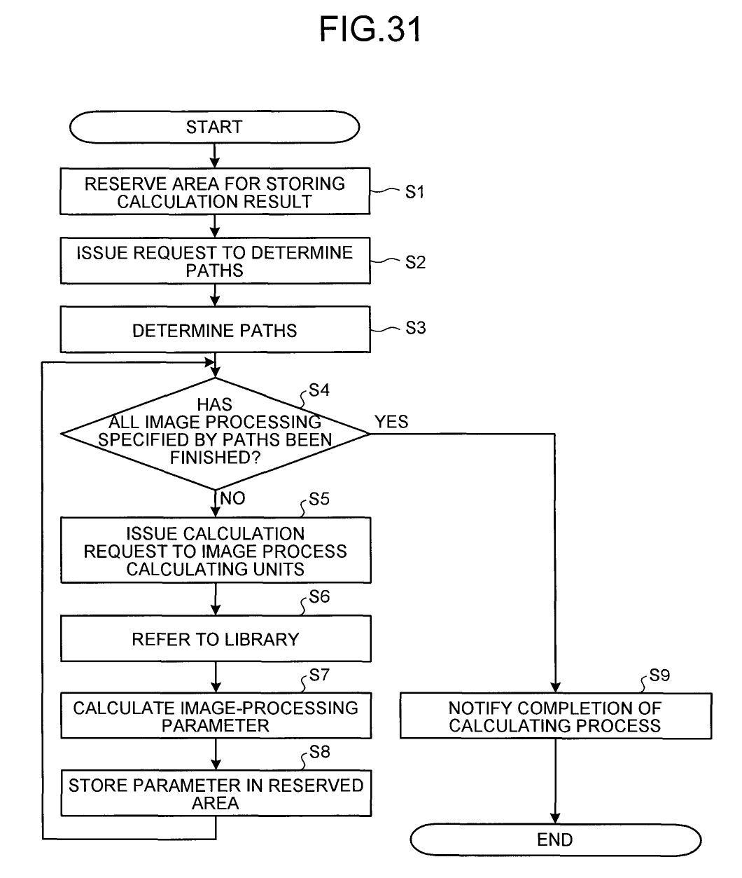

FIG. 31 is a flowchart of an example of a process performed by the image-processing control device 103 in response to a Calculation Request (CALC).

When the calculation is requested, no settings are provided to the data-processing device (ASIC) 104 or the data-processing devices (DSP) 104. Therefore, the entire process is performed within the setting-value calculating unit 1201 in the image-processing control device 103.

When the setting-value calculating unit 1201 receives a Calculation Request from the upper control device 102 based on information input from the operating unit 101, the manager 1603 reserves an area for generating and maintaining calculation results in the setting-value storage unit 1301 at step S1.

At step S2, a path determining request is sent to the path managing unit 1604. In response, at step S3, the path managing unit 1604 determines required image processing from the Calculation Request, and finds paths to the corresponding calculating unit.

At step S4, the manager 1603 determines if all the calculating units, located in the paths determined by the path managing unit 1604, have finished the processing (corresponding to all the image processing specified by the paths). However, because none of these processes have been completed at this point, the system control proceeds to step S5.

At step S5, the manager 1603 sequentially issues a calculation request (including information about all colors) to all the calculating units (the filter calculating unit 1606, the color-correction calculating unit 1607, and the modulation-process calculating unit 1608) following the paths determined by the path managing unit 1604.

At steps S6 and S7, upon receipt of the calculation request, the calculating units, which are located at the paths determined by the path managing unit 1604, calculate the image-processing parameters corresponding to each color of CMYK required to set to the data-processing device 104.

More specifically, at step S6, each of the calculating unit obtains corresponding values from the library 1605, determines if the value is an abstract parameter or an original value used for the calculation. If the value is an original value used for the calculation, the image calculating unit calculates image-processing parameters using the original value at step S7.

At step S8, the abstract parameters, or the calculated image-processing parameters are stored in the reserved area in the setting-value storage unit 1301.

The system control returns to step S4, and the manager 1603 again determines if all the calculating units, located at the paths determined by the path managing unit 1604, have completed their calculation processes. If not, the system control returns to step S5, and the above process is performed.

If all the calculating units have completed their calculation processes, it means that the every calculation has been completed. The system control moves to step S9 and sends a notification about completion of the calculations to the upper control device 102. When the upper control device 102 receives the notification, the entire process for the Calculation Request (CALC) is ended.

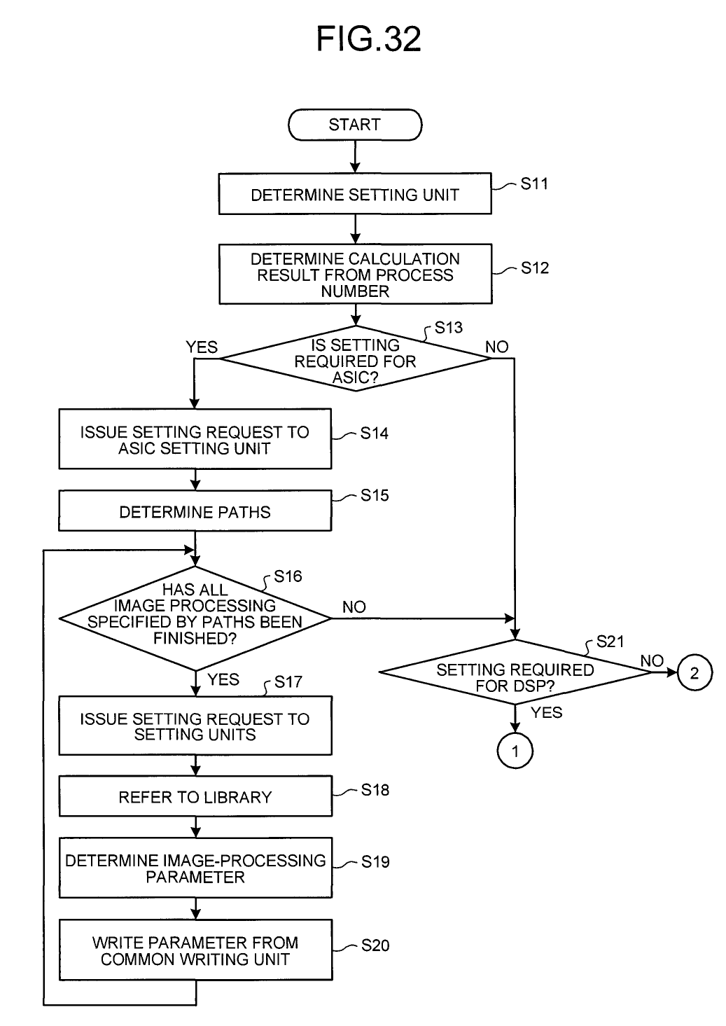

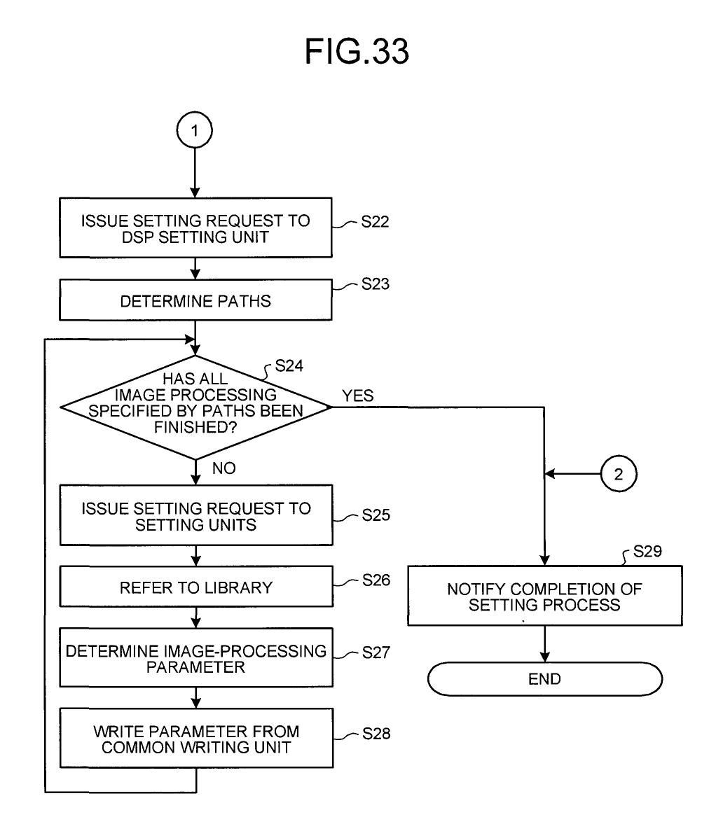

FIGS. 32 and 33 are a flowchart of an example of the process performed by the image-processing control device 103 of FIG. 22 in response to a Setting Request (SET).

Upon receipt of a Setting Request, the image-processing control device 103 needs to set corresponding image-processing parameters to the data-processing device (ASIC) 104 and the data-processing devices (DSP) 104. Therefore, the setting-value calculating unit 1201, the ASIC setting unit 1601, and DSP setting unit 1602 are required to perform their processing.

When the setting-value calculating unit 1201 receives a Setting Request (SET) from the upper control device 102 based on information input from the operating unit 101, the manager 1603 refers to the product-dependent information managing unit 1001 at step S11 to determine which setting unit(s) is to perform the setting operation. In this example, both of the ASIC setting unit 1601 and the DSP setting unit 1602 are determined to set image-processing parameters to the data-processing device (ASIC) 104 and the data-processing devices (DSP). The system control proceeds to step S12, the manager 1603 refers to the process number contained in the Setting Request (SET) (input information) and determines which information, created and stored in the setting-value storage unit 1301 in response to a certain Calculation Request (CALC), is to be used.

The system control proceeds to step S13, and the manager 1603 determines whether it is necessary to set image-processing parameters to the data-processing device (ASIC) 104 using the information determined at step S12. If necessary, a setting request is sent to the ASIC setting unit 1601 at step S14, and the system control proceeds to step S15.

At step S15, the manager 1609 sends the determined information from the setting-value storage unit 1301 to the path managing unit 1610. The path managing unit 1610 in turn determines type of image processing required, and further determines the paths to setting units corresponding to the required image processing.

At step S16, the manager 1609 determines if each of the setting units located in the paths determined by the path managing unit 1604 has finished the processing (all image processing specified by the paths). When the processing has not been finished, the system control proceeds to step S17.

At step 17, the manager 1609 sequentially issues a setting request (containing color specifying information) to each of the setting units over the paths determined by the path managing unit 1610.

Upon receipt of the setting request, each of the setting units, located in the paths determined by the path managing unit 1610, determines image-processing parameters required for the color unit specified by the color specifying information in the setting request at steps S18 and S19, and sends the determined information to the common writing unit 1615.

If a corresponding value in the setting-value storage unit 1301 is a calculated image-processing parameter, the setting unit outputs the value as it is to the common writing unit 1615.

If the corresponding value in the setting-value storage unit 1301 is an abstract parameter, the setting unit refers to the library 1611 at step S18 to obtain an ASIC parameter corresponding to the value specified by the abstract parameter. The setting unit determines the obtained value as the image-processing parameter at step S19, and outputs the value to the common writing unit 1615.

Upon receipt of the image-processing parameters, the common writing unit 1615 writes the image-processing parameters to the data-processing device (ASIC) 104 so that the received image-processing parameters are set thereto.

The system control returns to step S16, and the manager 1609 determines again if all the setting units located in the paths determined by the path managing unit 1604 have finished setting process thereof. If not, the system control returns to step S17, and the subsequent process takes place.

When all the setting units located in the paths determined by the path managing unit 1604 complete setting thereof, the manager 1609 send a notification about completion thereof to the manager 1603 in the setting-value calculating unit 1201.

Upon determining that no setting is required for the data-processing device (ASIC) 104, or upon receiving the notification about completion of the settings from the manager 1609, the manager 1603 further determines at step S21 if any setting is required for the data-processing device (DSP) 104 using the determined information.

If no setting is required, the manager 1603 determines that the setting process has been completed. The system control proceeds to step S29, and ends the process for the Setting Request (SET).

If setting is required in the data-processing device (DSP) 104, the manager 1603 sends a setting request to the DSP setting unit 1602 and the system control proceeds to step S23.

At step S23, the manager in the manager 1616 in the DSP setting unit 1602 sends the information, determined at the earlier step, from the setting-value storage unit 1301 to the path managing unit 1617. Upon receiving the information, the path managing unit 1617 determines image processing requested by the setting request, and find paths to the setting units corresponding to the determined image processing.

The DSP setting unit 1602 performs subsequent steps S24 to S28 that are almost the same as steps S16 to S20. Therefore, the explanations thereof are omitted herein.

At step S24, the manager 1616 determines that all the setting units, located in the paths determined by the path managing unit 1617, have finished setting thereof, and sends an ending request to the manager 1603 in the setting-value calculating unit 1201 to end the setting process.

Upon receiving the ending request from the DSP setting unit 1602, the manager 1603 sends an ending request to the upper control device 102 to end the setting process, and ends the process for the Setting Request (SET).

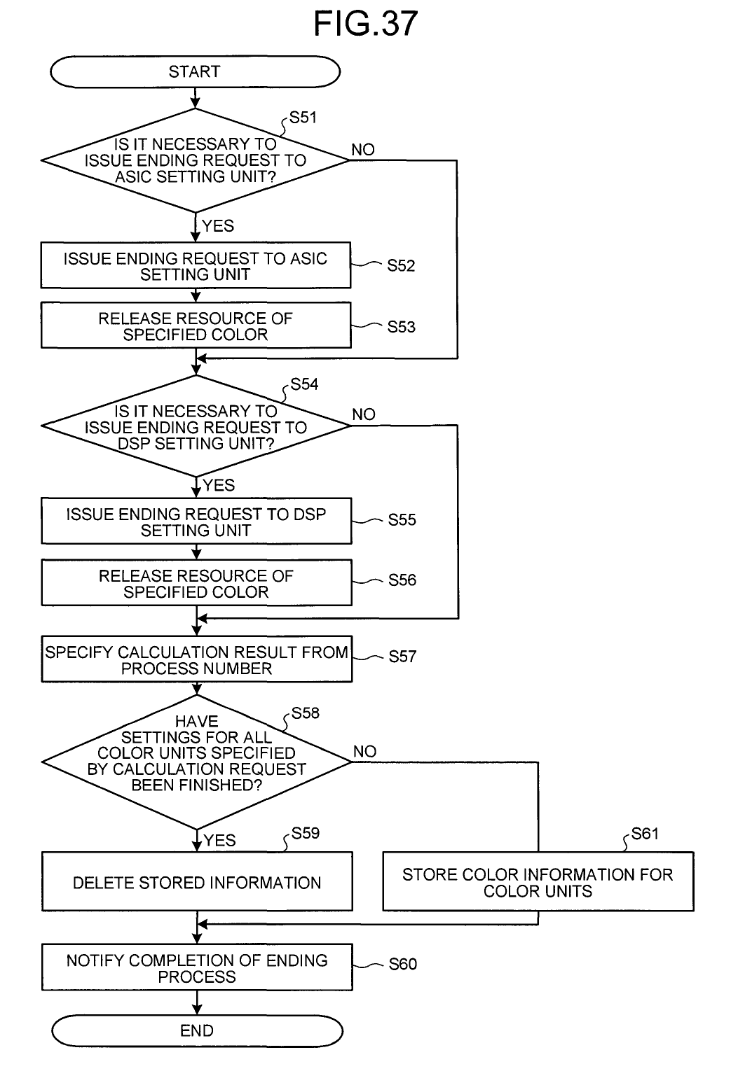

When the copy application is specified, the process is performed for the Setting Request. However, the actual process includes other steps such as determining a specified application, a specified process(es), that is, one or both of the scanner-related and plotter-related image processing, a specified color type, which is either monochrome or color, as shown in FIGS. 10, 13, and 16. In the explanation above, these steps are omitted to simplify the explanation thereof. The same applies to the following description of a seventh embodiment of the present invention, and the same steps are omitted (in FIG. 37) for the same reason in the description of the seventh embodiment.

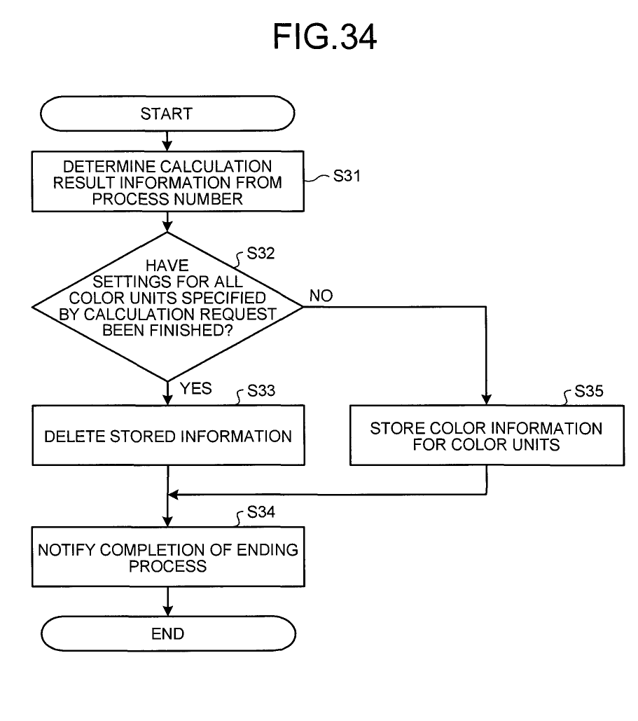

FIG. 34 is a flowchart of an example of a process performed by the image-processing control device 103 shown in FIG. 22 upon receipt of an Ending Request (END).

While an Ending Request (END) is processed, no settings are provided to the data-processing device (ASIC) 104 or to the data-processing device (DSP) 104. Therefore, the entire process is performed within the setting-value calculating unit 1201 in the image-processing control device 103.

Upon receiving an Ending Request (END) from the upper control device 102 based on information from the operating unit 101, the manager 1603 in the setting-value calculating unit 1201 refers to the process number included in the Ending Request (END) at step S31, and determines calculation result information stored in the setting-value storage unit 1301.

At the step S32, the manager 1603 further refers to the color specifying information in the Ending Request (END) to confirm that settings have been completed for all colors specified by the color specifying information included in the Calculation Request (CALC).

If the settings have been completed for all the colors, corresponding information in the setting-value storage unit 1301 is deleted at step S33 because the information is no longer needed.

If the settings have not yet completed for all the colors, color information for which the setting process has been completed is stored at step S35.

For example, in FIG. 19 where each of CMYK colors is specified by a corresponding setting request, the number of the colors for which the setting process has been completed is incremented in the sequence of K, Y, M, and C. An Ending Request (END) for the color C indicates that the settings for a first sheet have been completed. Therefore, upon receipt of such a request, corresponding information in the setting-value storage unit 1301 is deleted.

Finally at step S34, the manager 1603 notifies completion of the ending process to the upper control device 102, and the process ends.

As described above, according to the sixth embodiment, the product-dependent information, indicating which data-processing device 104 is responsible for image processing of which color unit, can be isolated from the image-processing control device 103 by allowing the image-processing control device 103 to connect with the middleware-based data-processing device 104 and the hardware-based data-processing device 104 in a communicative manner, and allowing corresponding image-processing parameters to be set to the middleware-based data-processing device 104 and the hardware-based data-processing device 104 respectively. Because an increased number of elements can be shared among different products, implementation of the data-processing device can be done more easily.

Furthermore, the middleware-based and the hardware-based data-processing device 104 can perform the image processing based on the image-processing parameters respectively set thereto. Therefore, a high-performance pursuing MFP can be provided with the middleware-based and the hardware-based data-processing devices 104, each corresponding to each color unit. In this manner, the image processing can be performed for each of the color units, and the performance thereof can be improved. A low-cost pursuing MFP can be provided with a single middleware-based or a hardware-based data-processing device 104 that performs the image processing for all color units. In this manner, the number of data-processing devices can be reduced, allowing cost reduction. Not only by enabling the image-processing control device 103 to control one or more middleware-based and hardware-based data-processing devices 104 but also by isolating the product-dependent information from the image-processing control device 103, these elements can be shared among products.

Described below is a seventh embodiment of the present invention. The seventh embodiment is basically similar to the sixth embodiment, and therefore, the difference is mainly explained below.

According to the seventh embodiment, the MFP performs the image processing for each color of CMYK in the same manner as previously explained in connection with FIG. 19. If a setting request is issued for an data-processing device 104 performing the image processing, the data-processing device 104 cannot accept a write request while receiving image data and performing the image processing thereto. Therefore, the image processing cannot be performed correctly, resulting in an erroneous image.

According to the seventh embodiment, the image-processing control device 103 manages the resource to avoid the erroneous settings when the image-processing control device 103 receives a Setting Request (SET) for the data-processing device 104 performing the image processing from the upper control device 102.

The same process is performed in response to the Calculation Request (CALC) as in the sixth embodiment previously described in connection with FIG. 31. Therefore, the explanation thereof is omitted herein.

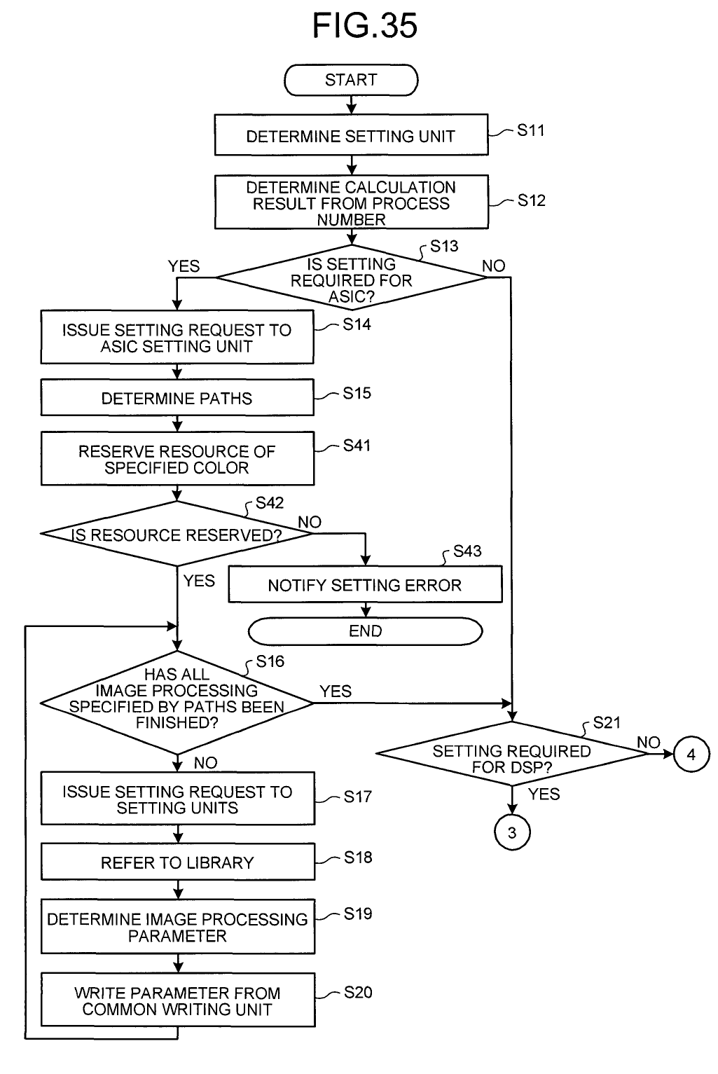

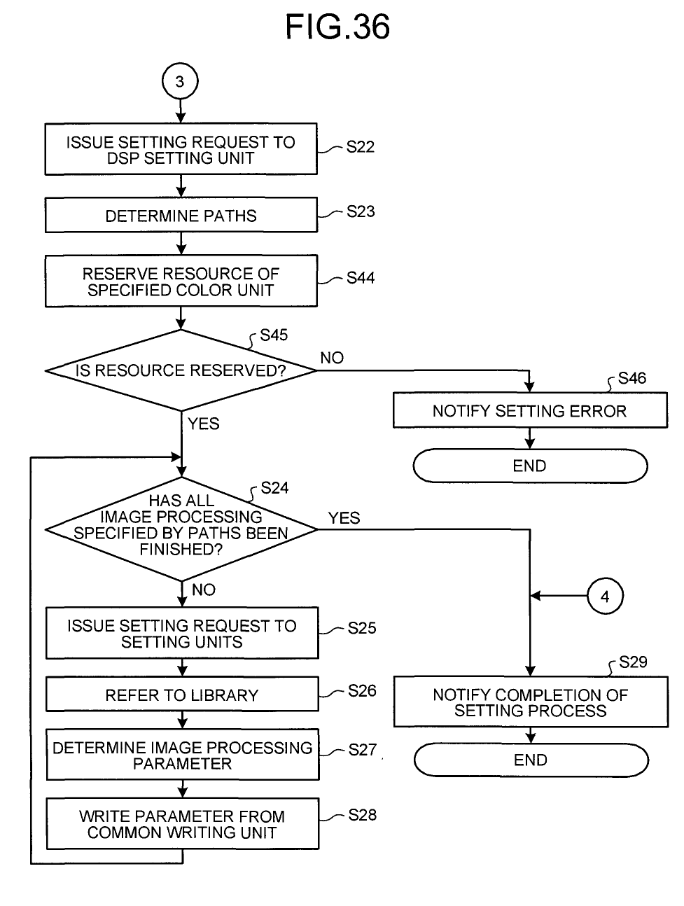

FIGS. 35 and 36 are flowcharts of another example of a process performed by the image-processing control device 103 in response to a Setting Request (SET).

This process is in many respects similar to that previously described in connection with FIGS. 32 and 33 in the sixth embodiment, and only different steps are described below.

After the manager 1609 determines the paths to the setting units at step S15 in FIG. 35, the path managing unit 1610 reserves the data-processing device (ASIC) 104 (corresponding to specified color unit), which is a resource used for the image processing corresponding to the color unit specified in color specifying information contained in the Setting Request (SET) at step S41. Resources are managed as array data, so that the resources are reserved for the setting units located at the determined path for RGBCMYK colors.

At the time the MFP is powered on, the resources for each of the RGBCMYK color units are at “RELEASE” status. Upon receipt of a Setting Request (SET) specifying a color unit, only the corresponding resource is set to “GET” status for the corresponding setting unit located at the determined path.

If the data-processing device (ASIC) 104 is already set to “GET” status when a reservation attempt is made at step S41, the data-processing device (ASIC) 104 is currently performing the image processing of the color. Therefore, the manager 1609 cannot set image-processing parameters to the data-processing device (ASIC) 104.

If it is determined impossible to reserve the data-processing device (ASIC) 104 at step S42, the system control proceeds to step S43, and the manager 1609 sends a setting error to the upper control device 102.

Upon receipt of an error notification, the upper control device 102 sends the Setting Request (SET) for that color again to the setting-value calculating unit 1201 after a predetermined time has elapsed.

If the manager 1609 in the ASIC setting unit 1601 determines that the data-processing device (ASIC) 104 is reserved at step S42, the system control proceeds to step S17.

The manager 1616 in the DSP setting unit 1602 performs each of steps S44 to S46 after determining the paths to the setting units at step S23 in FIG. 36. These steps S44 to S46 are almost the same as steps S41 to S43 in FIG. 35 performed by the manager 1609. Therefore, the explanations thereof are omitted herein.

FIG. 37 is a flowchart of another example of a process performed by the image-processing control device 103 shown in FIG. 22 upon receipt of an Ending Request (END).

In the sixth embodiment, in response to an Ending Request (END) received at the image-processing control device 103, no ending request is sent to the ASIC setting unit 1601 or the DSP setting unit 1602. However, in the seventh embodiment, to release the resources, i.e., the data-processing devices 104, reserved by the path managing unit 1610 or the path managing unit 1617 in response to the Setting Request (SET), the manager 1603 in the setting-value calculating unit 1201 sends ending requests to the ASIC setting unit 1601 and the DSP setting unit 1602.

In other words, upon receiving an Ending Request (END) from the upper control device 102 based on the information from the operating unit 101, the manager 1603 in the setting-value calculating unit 1201 first determines if it is necessary to send an ending request to the ASIC setting unit 1601. If necessary, an ending request is sent to the ASIC setting unit 1601.

Upon receiving the ending request, the path managing unit 1610 in the ASIC setting unit 1601 performs step S53 described below.

After the data-processing device (ASIC) 104 completes the image processing using the image-processing parameters of the color unit set by one of the setting units located at the paths determined for a Setting Request (SET), the path managing unit 1610 set the status of the data-processing device (ASIC) 104 to “RELEASE”. Subsequently, the path managing unit 1610 sends a resource release complete request to the manager 1603 in the setting-value calculating unit 1201.

If the manager 1603 in the setting-value calculating unit 1201 determines that it is not necessary to send an ending request to the ASIC setting unit 1601, or receives a resource release complete request from the path managing unit 1610 in the ASIC setting unit 1601, the manager 1603 further determines if it is necessary to send an ending request to the DSP setting unit 1602 at step S54. If necessary, an ending request is sent to the DSP setting unit 1602 at step S55.

Upon receiving the ending request, the path managing unit 1617 in the DSP setting unit 1602 performs steps S55 and S56. Because steps S55 and S56 are approximately the same as steps S52 and S53 explained for the ASIC setting unit 1601 above, the explanation thereof are omitted herein.

If the manager 1603 in the setting-value calculating unit 1201 determines that it is not necessary to send an ending request to the DSP setting unit 1602, or receives a resource release complete request from the path managing unit 1617 in the DSP setting unit 1602 upon completion of step S56, steps S57 to S61 are performed. Because these steps S57 to S61 are the same as steps S31 to S35 in FIG. 34, explanation thereof are omitted herein.

By allowing the ASIC setting unit 1601 and the DSP setting unit 1602 to manage resources, the data-processing device (ASIC) 104 or the data-processing device (DSP) 104 can be prevented from accepting a setting request while performing the image processing. As a result, an erroneous image output, due to performing the setting while performing the image processing, can be prevented.

According to the seventh embodiment, by enabling the image-processing control device 103 to control the status of the middleware-based and the hardware-based data-processing devices 104 for each color unit, no setting request can cause the image-processing parameters of each color to be set to the middleware-based and the hardware-based data-processing devices 104 while performing the image processing. Therefore, an erroneous image output, due to the setting operation, can be avoided.

In the embodiments described above, the present invention is applied to an MFP. However, the present invention can also be applied to other types of image forming apparatus such as a digital copier with an image reading device (such as a scanner), or a facsimile machine. The present invention can also be applied to a printer or a PC connectable to an image reading device. Moreover, the present invention can be applied to various image-processing apparatuses such as a stand-alone image reader.

As set forth hereinabove, according to an embodiment of the present invention, information is separately obtained with respect to each data-processing device to be used for image processing of each color. Therefore, more elements can be shared among different types of data-processing devices. Thus, a data-processing device can be easily mounted on or connected to an image processing apparatus.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image-processing control device that is configured to be communicatively connected to an image processing apparatus that performs image processing on image data based on processing parameters, the image-processing control device comprising:
a parameter setting unit that sets a processing parameter on the image processing apparatus with respect to each of colors of color image data, or groups the colors of the color image data into at least a single set of colors and sets a processing parameter on the image processing apparatus with respect to the set of colors.

2. The image-processing control device according to claim 1, wherein the parameter setting unit sets the processing parameter based on a channel assigned to each of the colors of the color image data.

3. The image-processing control device according to claim 1, wherein the image processing apparatus performs predetermined processing with respect to each color of image data.

4. The image-processing control device according to claim 1, wherein the parameter setting unit includes a calculating unit that calculates the processing parameter.

5. The image-processing control device according to claim 4, wherein the parameter setting unit includes a storage unit that stores therein the processing parameter obtained by the calculating unit.

6. The image-processing control device according to claim 4, wherein
the image processing apparatus includes a middleware image processing apparatus and a hardware image processing apparatus,
the calculating unit calculates a first processing parameter corresponding to the middleware image processing apparatus and a second processing parameter corresponding to the hardware image processing apparatus, and
the parameter setting unit includes
a middleware setting unit that sets the first processing parameter on the middleware image processing apparatus; and
a hardware setting unit that sets the second processing parameter on the hardware image processing apparatus.

7. The image-processing control device according to claim 6, wherein the calculating unit calculates a third processing parameter that can be set by both the middleware setting unit and the hardware setting unit.

8. The image-processing control device according to claim 6, wherein the parameter setting unit includes a management unit that manages state of the middleware image processing apparatus and the hardware image processing apparatus with respect to each color.
